(19) United States
(12) Patent Application Publication
(10) Pub. No.: US 2008/0040927 A1
(43) Pub. Date: Feb. 21, 2008

(54) ELECTRIC SHAVER AND TRIMMER

(76) Inventor: Tung Yan LAU, Hong Kong, (CN)

Correspondence Address: OSTROLENK FABER GERB & SOFFEN, 1180 AVENUE OF THE AMERICAS, NEW YORK, NY, 100368403, US

(21) Appl. No.: 11/465,147

(22) Filed: Aug. 17, 2006

(51) Int. Cl. B26B 19/00

(52) U.S. Cl. 30/34.1

(57) ABSTRACT

An electric shaver and trimmer for use in shaving and trimming armpit hair includes a body and at least one attachment removably attached to the head end of the body, the attachment including a shaver and a trimmer, the trimmer having a convex stationary blade connected to the attachment and a convex cutting blade at least partially within the attachment movable against the convex stationary blade. In one embodiment, the electric shaver includes two interchangeable attachments, each having a different shape trimmer blade for use on different areas of the body. In another embodiment, the electric shaver includes a selector that can be used to select either operation of only the shaver or operation of only the trimmer by actuating the selector between a first position and a second position.

### FIELD OF THE INVENTION

The present invention relates generally to an electric shaver, and more specifically, an electric armpit shaver and trimmer.

### BACKGROUND OF THE INVENTION

A variety of electric razors and electric shavers are presently available on the market. Electric razors generally employ blades that are driven by an electric motor to trim hair when the electric razor is placed against the skin. When contact is made between the electric shaver and hair, the hair is cut by the driven blades.

Presently, there are limitations to electric shavers when used in the armpit area. It is often difficult to trim or shave the armpit area using presently available electric shavers and razors, and pain and irritation is common after use.

Accordingly, there remains a need for an electric shaver that addresses the present limitations and shortcomings of existing electric shavers.

### SUMMARY OF THE INVENTION

According to one embodiment of the invention, an electric shaver is disclosed. The electric shaver includes a body having a head end and a motor contained within the body, the motor having a motor shaft coupled to a driveshaft, the body further having a power source for operating the motor, and a switch for engaging the motor; an attachment removably attached to the head end of the body, the attachment operably coupled to the driveshaft, the attachment including a shaver and a trimmer, the trimmer including a convex stationary blade connected to the attachment and a convex cutting blade at least partially within the attachment movable against the convex stationary blade; and wherein during rotation of the driveshaft, the driveshaft drives operation of the shaver and the trimmer.

According to another embodiment of the invention, an electric shaver is disclosed. The electric shaver includes a body having a head end and a motor contained within the body, the motor having a motor shaft coupled to a driveshaft, the body further having a power source for operating the motor, and a switch for engaging the motor; a first attachment configured for removable attachment to the head end of the body, the first attachment including a shaver and a convex trimmer, wherein upon attachment to the body, the first attachment is operably coupled to the driveshaft, wherein the first attachment includes a convex stationary blade connected to the attachment and a convex cutting blade at least partially within the attachment movable against the convex stationary blade, and wherein the driveshaft drives operation of the shaver and convex trimmer; and a second attachment configured for removable attachment to the head end of body, the second attachment including a concave trimmer, wherein upon attachment to the body, the second attachment is operably coupled to the driveshaft, wherein the second attachment includes a concave stationary blade connected to the attachment and a concave cutting blade at least partially within the attachment movable against the concave stationary blade, and wherein the driveshaft drives operation of the concave trimmer.

According to another embodiment of the invention, an electric shaver is disclosed. The electric shaver includes a body having a head end, a handle, and a motor, a driveshaft, and a universal joint contained within the body, the motor having a motor shaft, wherein the motor shaft is coupled to the driveshaft by the universal joint, the body further having a power source for operating the motor, and a switch for engaging the motor, wherein the head end forms a predetermined angle with the handle; an attachment removably attached to the head end of the body, the attachment operably coupled to the driveshaft, the attachment including a shaver and a trimmer, the trimmer including a convex stationary blade connected to the attachment and a convex cutting blade at least partially within the attachment movable against the convex stationary blade, and wherein during rotation of the driveshaft, the driveshaft drives operation of the shaver and the trimmer, the attachment further including a selector movable between a first position and a second position, a selector control plate, and a moving arm movable by the selector control plate, wherein the moving arm drives the convex cutting blade, and when the selector is located in the first position, the driveshaft engages the shaver individually, and when the selector is located in the second position, the driveshaft engages the moving arm individually.

### BRIEF DESCRIPTION OF THE DRAWINGS

These and other features, aspects, and advantages of the present invention will become better understood with regard to the following description and accompanying drawings where:

FIG. 1A is a perspective view of the electric shaver with the convex trimmer and shaver attachment;

FIG. 1B is an illustration showing example usages of the electric shaver with the convex trimmer and shaver attachment applied to the skin surface;

FIG. 2 is a top view of the electric shaver with the convex trimmer and shaver attachment, having the upper housing removed, showing the internal parts;

FIG. 3 is a perspective front view of the convex trimmer and shaver attachment;

FIG. 4 is a perspective rear view of the convex trimmer and shaver attachment;

FIG. 5 is an exploded view of the convex trimmer and shaver attachment showing the internal parts;

FIG. 6 is a sectional view of the convex trimmer and shaver attachment;

FIG. 7 is a detailed exploded view of some areas of the convex trimmer and shaver attachment;

FIG. 8 is a perspective rear view of the convex trimmer and shaver attachment shown in FIG. 7;

FIG. 9 is a front view of a convex stationary blade used in the convex trimmer;

FIG. 10 is a front view of a convex movable blade used in the convex trimmer;

FIG. 11 is a perspective view of a clamping system of the convex movable blade used in the convex trimmer;

FIG. 12 is an exploded view of the clamping system shown in FIG. 11;

FIG. 13 is a perspective view of a universal joint used in the shaver;

FIG. 14 is a perspective sectional view of the universal joint shown in FIG. 13, showing the transmission principle of the motor driving mechanism for the shaver;

FIG. 15 is a perspective view of the eccentric shaft of the universal joint shown in FIG. 13;

FIG. 16 is an end view of the eccentric shaft shown in FIG. 15;

FIG. 17 is a perspective view of the electric shaver with a concave trimmer attachment;

FIG. 18 is a top sectional view of the electric shaver with the concave trimmer attachment, with the upper housing removed, showing the internal parts;

FIG. 19 is a perspective front view of the concave trimmer attachment;

FIG. 20 is a perspective rear view of the concave trimmer attachment;

FIG. 21 is an exploded view of the concave trimmer attachment showing the internal parts;

FIG. 22 is a side sectional view of the concave trimmer attachment;

FIG. 23 is a perspective rear view of the concave trimmer attachment with the cover removed;

FIG. 24 is a top view of a concave stationary blade used in the concave trimmer attachment;

FIG. 25 is a top view of a concave movable blade used in the concave trimmer attachment;

FIG. 26 is a perspective view of the electric shaver with a convex trimmer and shaver attachment with selector;

FIG. 27 is a perspective front view of the convex trimmer and shaver attachment with selector;

FIG. 28 is a perspective rear view of the convex trimmer and shaver attachment with selector;

FIG. 29 is an exploded view of the convex trimmer and shaver attachment with selector, showing the internal parts;

FIG. 30 is a perspective rear view of the convex trimmer and shaver attachment with selector;

FIG. 31 is a detailed exploded view of a part of the convex trimmer and shaver attachment with selector;

FIG. 32 is a sectional view of the convex trimmer and shaver attachment with selector, with the selector in a shaver only position;

FIG. 33 is a sectional view of the convex trimmer and shaver attachment with selector, with the selector in a trimmer only position;

FIG. 34 is a schematic diagram showing the working principle of the selector in the convex trimmer and shaver attachment with selector;

FIG. 35 is a schematic diagram showing the driving principle of the blades of the convex trimmer and shaver attachment;

FIG. 36 is a schematic diagram showing the driving principle of the blades of the concave trimmer attachment; and

FIG. 37 is a schematic diagram showing the driving principle of the trimmer blades and shaver blades of the convex trimmer and shaver attachment with selector.

### DETAILED DESCRIPTION

The detailed description set forth below in connection with the appended drawings is intended as a description of example embodiments of the present invention and it is not intended to represent the only embodiments in which the present invention can be practiced. The embodiments described throughout this description are intended to serve as examples or illustrations of the present invention and should not necessarily be construed as preferred or advantageous over other embodiments. Any number of the described embodiments may be incorporated in any desired combination. The detailed description includes specific details for the purpose of providing a thorough understanding of the present invention. However, it will be apparent to those skilled in the art that the present invention may be practiced without certain specific details.

In the following description, reference is made to the accompanying drawings, which forms a part hereof, in which specific embodiments of the invention are shown by way of illustration. It is to be understood that other embodiments may be used as structural and other changes may be made without departing from the scope of the present invention.

Generally, one embodiment of the present invention provides for an electric shaver and trimmer for use in shaving and trimming armpit hair. However, embodiments of the present invention may be used on any desired areas of the body. In one embodiment, the shaver includes a body and a convex trimmer and shaver head coupled to the body. The body is generally elongate in shape, having a shape suitable for holding in the hand of a user. In another embodiment, the shaver includes a body and two detachable attachments, a convex trimmer and shaver attachment and a concave trimmer attachment. Each of the attachments may be removably attached to the shaver body for use. In another embodiment, the convex trimmer and shaver attachment includes a selector that can be used to select either operation of only the shaver or operation of only the trimmer by actuating, or turning, the selector located on one side of the attachment.

In one embodiment, by providing two, interchangeable attachments, one having convex shaped trimmer blades and one having concave shaped trimmer blades, each trimmer attachment can be used on different areas of the armpit area, matching the curvature of the trimmer blades.

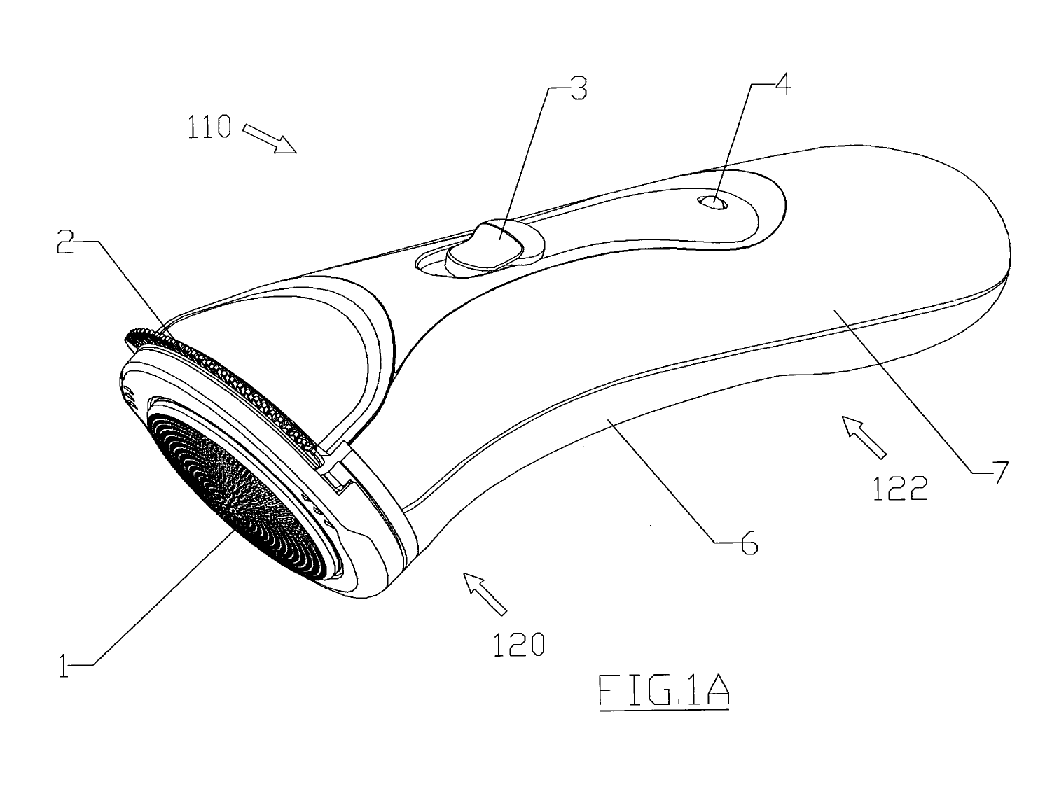

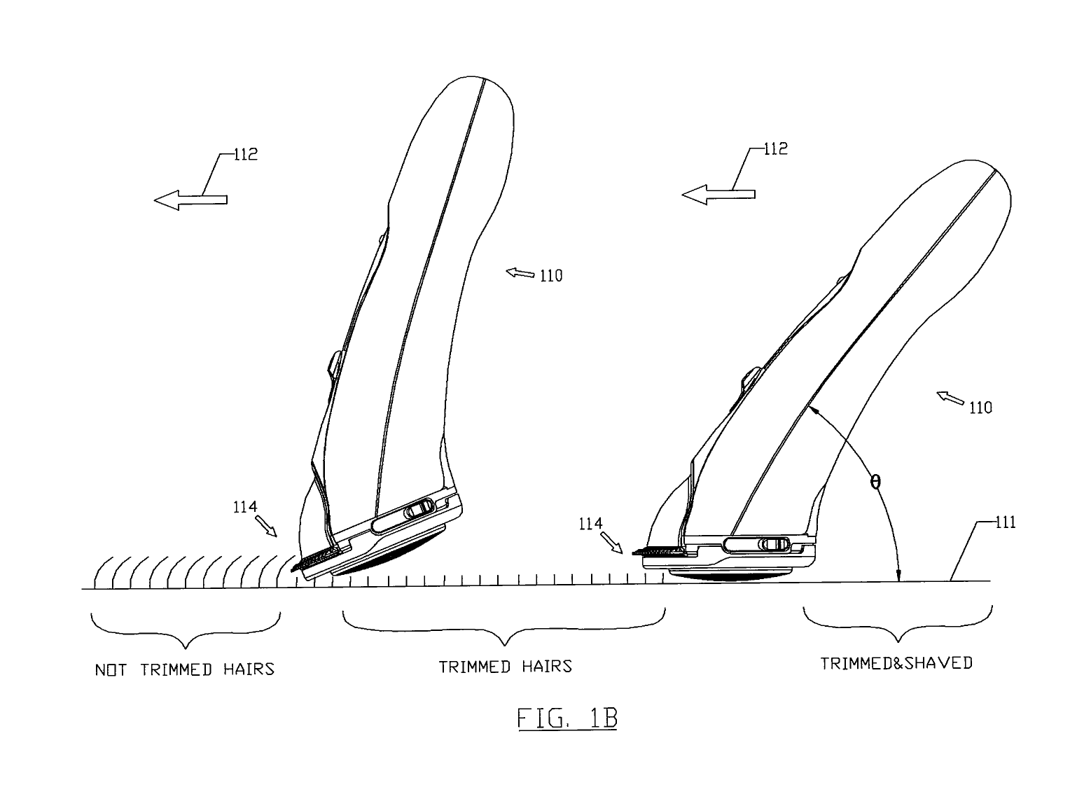

Referring now to the figures, FIG. 1A is a perspective view of an electric shaver 110 with the convex trimmer and shaver attachment. In the illustration, the convex trimmer and shaver attachment includes a shaver foil 1 and a stationary cutting blade 2. The body of the shaver includes a power switch 3, a light emitting diode (“LED”) indicator 4, a lower housing 6, and an upper main housing 7. The electric shaver 110 has a shape and size that fits generally within the hand of the user. A head end of the body is generally indicated to by reference number 120. The head end 120 of the body is the area of the body that receives the shaver and trimmer attachment, or is the area where the shaver and trimmer components are located. A handle or handle end of the body is generally indicated by reference number 122. The handle is the area that may be held in the users hand during operation of the electric shaver.

FIG. 1B is an illustration showing example usages of the electric shaver 110, having the convex trimmer and shaver attachment, when applied to the skin surface. In a first illustrated position of the electric shaver 110, the shaver foil is generally flush against the skin surface 111, which is illustrated by the horizontal line having a “trimmed and shaved” section, a “trimmed hairs” section, and a “not trimmed hairs” section. Arrows 112 illustrate one direction of use, illustrating that the electric shaver 110 is moved generally in the direction of the arrows 112 across the skin surface 111. However, the shaver 110 may also be moved in any other direction, including laterally and circular motion. When using the trimmer feature, the electric shaver 110 is moved generally in a direction toward the side where the trimmer is located on the electric shaver 110.

The product shape may be designed in such a way that the trimmer and shaver head is inclined at an angle θ to the central axis of the handle. The inclined trimmer and shaver head assists in providing a suitable handling position when used in the armpit areas. In one embodiment, the angle θ is less than approximately 90 degrees, however any suitable angle may be used. In another embodiment, the trimmer and shaver head is not angled and faces generally in the direction of the central axis of the handle. In first position, the angle θ is also the angle that the central axis of the handle forms with the illustrated skin surface 111.

In a second illustrated position of the electric shaver 110, the shaver foil is generally raised from the skin surface, the angle that the central axis of the handle forms with the skin surface increasing from that shown in the first position. When the shaver foil is raised from the skin surface, the trimmer portion 114 of the trimmer and shaver head may be moved across the skin surface to trim the hairs. The trimmer 114 may also be used while the shaver foil is generally flush against the skin surface, however, by raising the shaver foil, the trimmer 114 is brought closer to the skin surface, and the hairs are trimmed to a shorter length.

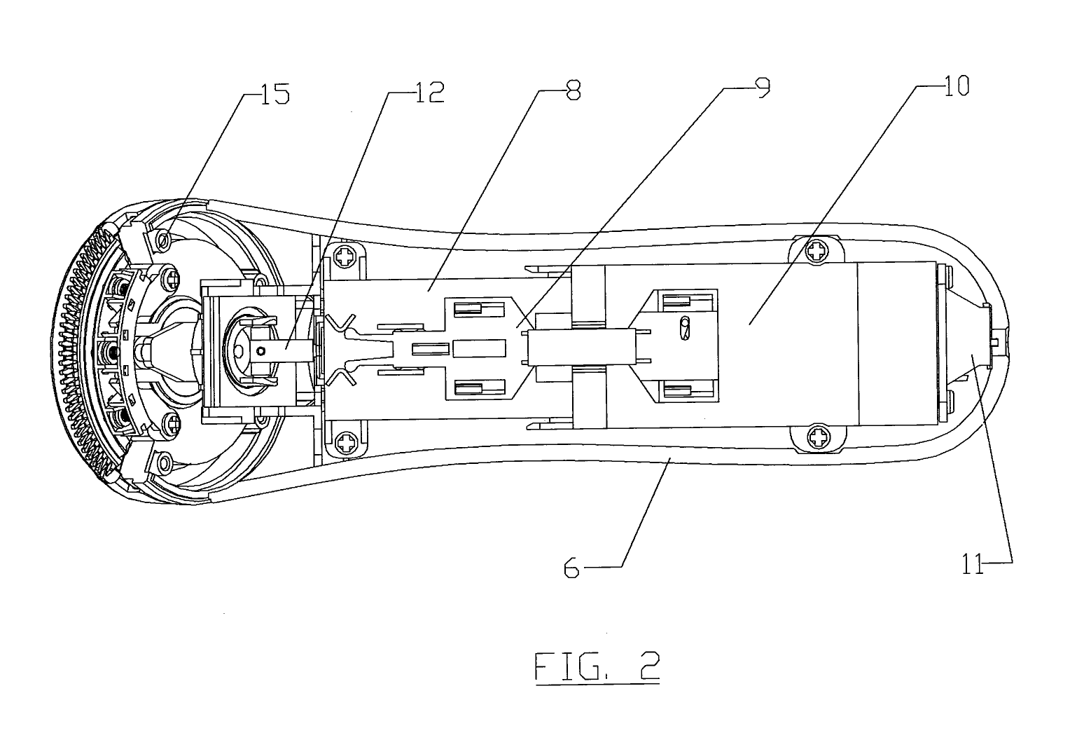

FIG. 2 is a top view of the electric shaver with the convex trimmer and shaver attachment, having the upper housing removed, showing the internal parts. Shown generally in the lower housing 6 are a universal joint, generally indicated at reference number 12, a front cover 15 of the attachment, a motor housing 8, a switch lever 9, a battery housing 10, and a charging contacts holder 11. The motor housing 8 is used to locate and support the motor and also to isolate the motor from contact with any water that could leak into the housing, which in one embodiment is waterproof or water resistant. The switch lever 9 is the linkage between the power switch 3 and internal switch contacts and is used to turn the electric shaver on and off. The battery housing 10 is used to locate and isolate the rechargeable battery from contact with any water leakage. The charging contacts holder 11 supports the contacts that are used for charging the battery.

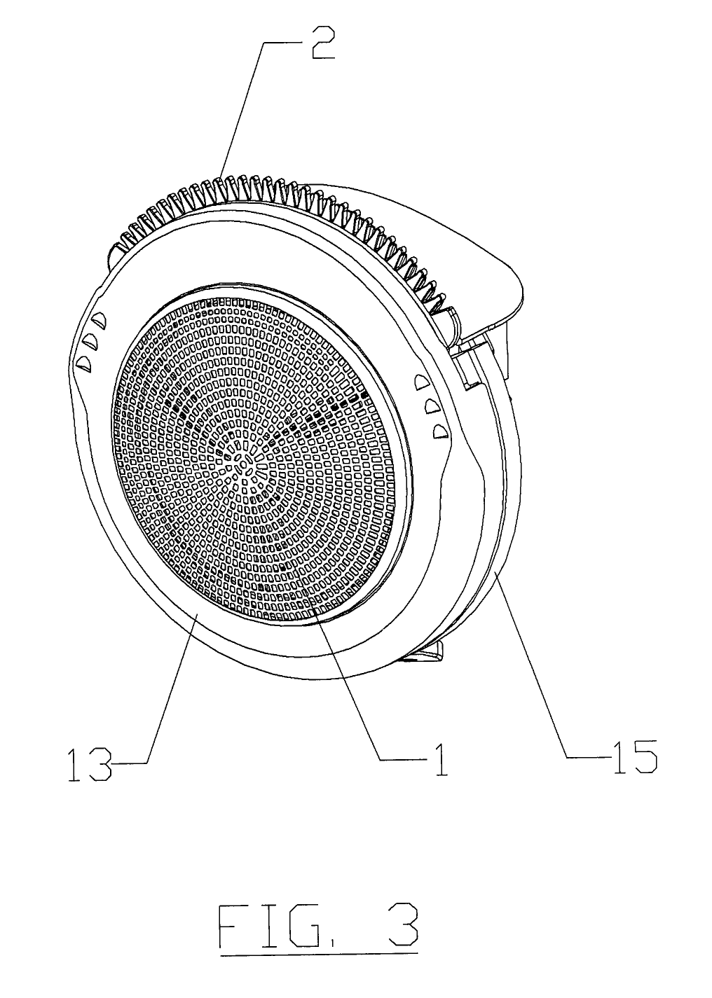

FIG. 3 is a perspective front view of the convex trimmer and shaver attachment. The convex trimmer and shaver attachment is shown detached from the shaver body. The convex trimmer and shaver attachment includes the shaver foil 1, a shaver cover 13, and the stationary cutting blade 2 located on the outer circumference of the attachment. The front cover 15 of the attachment also can be seen in the illustration. One purpose of the trimmer portion of the attachment is to trim hairs in the armpit areas before shaving with the shaving foil 1.

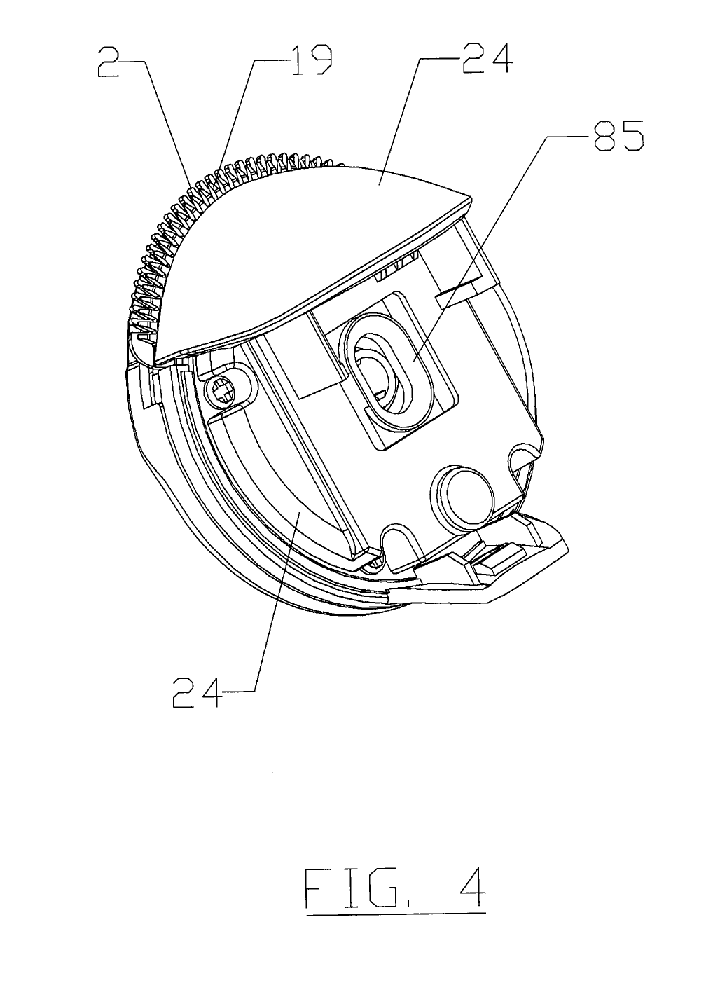

FIG. 4 is a perspective rear view of the convex trimmer and shaver attachment. Shown in the rear view of the attachment are the stationary cutting blade 2, the convex movable blade 19, a rear cover 24, and an oval-shaped, slotted hole 85 defined by the moving arm 23 (partially shown).

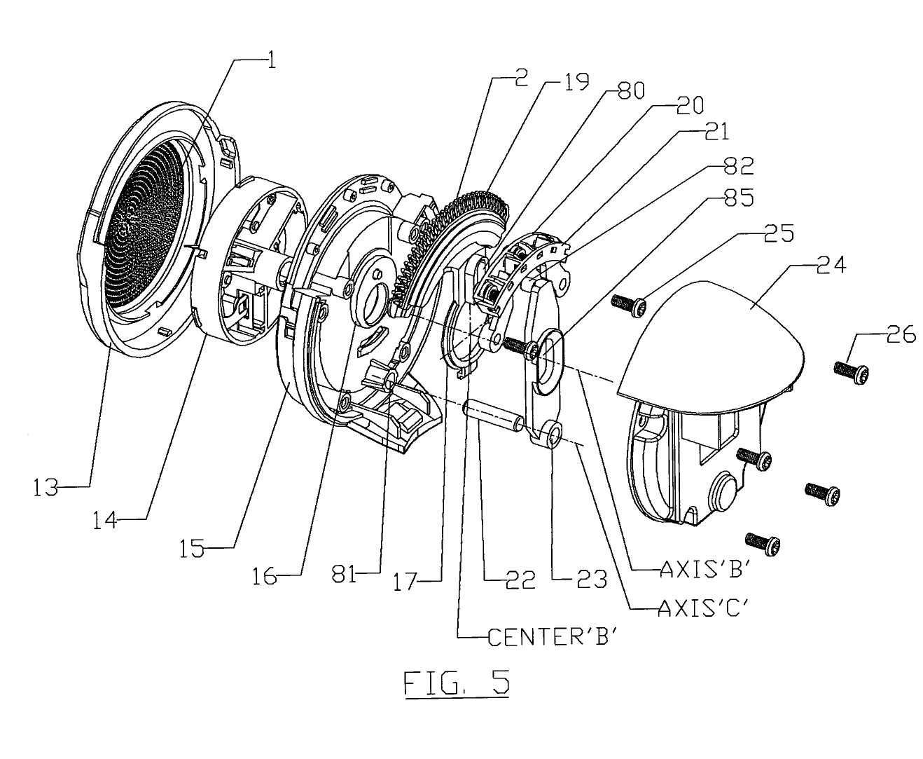

FIG. 5 is an exploded view of the convex trimmer and shaver attachment showing the internal parts. Shown in the exploded view are the shaver foil 1, the stationary cutting blade 2, the shaver cover 13, a shaver cutter 14, the front cover 15, a brass bushing 16, a moving blade holder 17, the convex movable blade 19, a front clamp 20, a rear clamp 21, a metal shaft 22, a moving arm 23, the rear cover 24, clamping system fasteners 25, rear cover fasteners 26, a U-shaped slot 80, a shaft hole 81 defined by the front cover 15, a pin 82, and the slotted hole 85.

The shaver cover 13 holds and supports the shaver foil 1 and is the portion of the shaver applied against the skin during operation by the user. The shaver cover 13 is removably attached to the front cover 15 and holds the shaver cutter 14 in the attachment between the shaver cover 13 and the front cover 15. The shaver cover 13 may be removed to clean the shaver foil 1, to clean and replace the shaver cutter 14, and to clean to area between the shaver cover 13 and the front cover 15.

The shaver includes the shaver foil 1, the shaver cutter 14, and the shaver cover 13. The shaver foil 1 may be any suitable shaver screen or foil with holes, slots, or other opening that allows hair to pass through the shaver foil 1 to be cut by the shaver cutter 14. Any suitable shaver cutter 14 may be used. In the illustrated embodiments, the shaver cutter 14 is a generally cylindrical component configured for engagement with the eccentric shaft 29, which during engagement is driven in rotation by the eccentric shaft 29. The shaver cutter 14 may include one or more blades disposed on the cylindrical component. The shaver cutter 14, during operation, is disposed against the shaver foil 1 and driven in rotation, whereby the one or more blades cut hair that passes through the shaver foil 1. One example of the shaver is shown in the appended figures. Other configurations of the shaver may be used with embodiments of the present invention.

The fasteners in the illustrated embodiments of the invention, such as the clamping system fasteners 25 and the rear cover fasteners 26, may be any suitable fastener to keep the various parts in the appropriate positions. The fasteners may be screws, bolts, rivets, pins, rods, dowels, welds, adhesives, or any other type of suitable fastener or connector. Also, as shafts, pins and other fasteners are also illustrated, it is to be understood that these fasteners are not necessarily limited to any particular type of fastener but may also be any suitable fastener or connector.

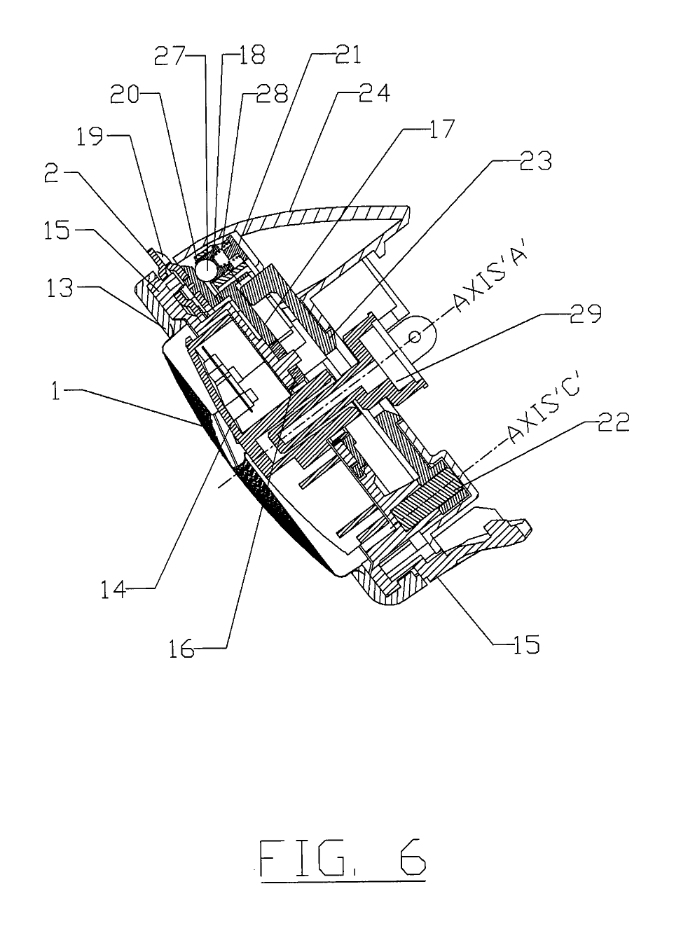

The convex movable blade 19 is mounted onto the moving blade holder 17. During operation of the shaver 110, the moving blade holder 17 is pivoted about center B on the brass bushing 16 so that the convex movable blade 19 moves radially about center B, about axis B. The convex movable blade 19 is driven by the moving arm 23 at the location of the U-shape slot 80 of the moving blade holder 17. The moving arm 23 is pivoted about the metal shaft 22, which is fixed into the shaft hole 81 in the front cover 15. The moving arm 23 moves radially about the metal shaft 22 about axis C. This radial motion is then transmitted to the moving blade holder 17 by using the pin 82, which may be integrally molded in the moving arm 23. The pin 82 is inserted into the U-shape slot 80 of the moving blade holder 17. Therefore, the operation of the attachment can be driven by the eccentric shaft 29 (see, for example, FIGS. 6, 13, and 14) positioned of the slotted hole 85 of the moving arm 23.

FIG. 6 is a sectional view of the convex trimmer and shaver attachment. Like reference numerals will be used to refer to like components throughout this application, unless otherwise specified. Therefore, reference numbers used previously with reference to FIG. 5 are similarly used in FIG. 6, and the following figures, to identify components of the convex trimmer and shaver attachment. Also illustrated in FIG. 6 is the eccentric shaft 29, which rotates about axis A.

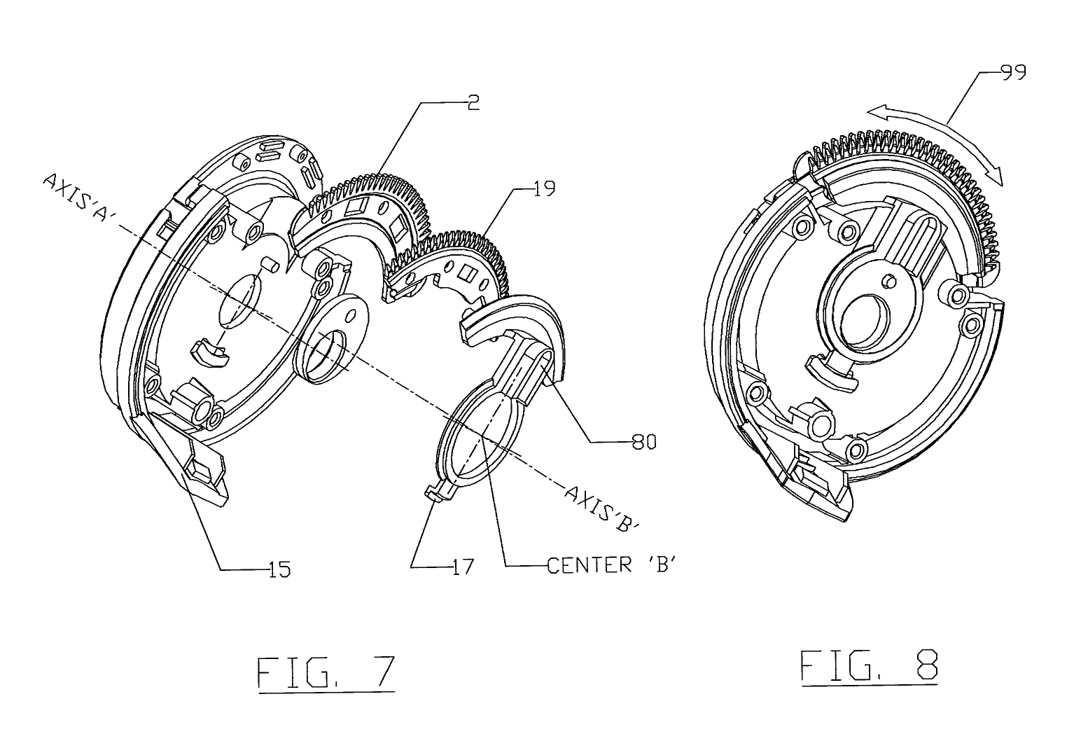

Referring now to FIG. 7, a detailed exploded view of one area of the convex trimmer and shaver attachment is shown. During operation of the shaver 110, the convex movable blade 19 swivels about axis B, creating a back and forth rotational movement. It can also be seen in FIG. 7 that, in one embodiment, axis A and axis B are not the same but are generally parallel to each other.

FIG. 8 is a perspective rear view of the convex trimmer and shaver attachment shown in FIG. 7. It is to be noted that the convex movable blade 19 does not operated in a linear direction, but instead swivels about axis B (shown in FIG.7) in a rotational motion, back and forth as illustrated by a direction arrow 99 in FIG. 8. Also, the convex shape of the trimmer blades is suited for applying to the underarm areas, which has a shape like the inner side of part of a sphere that is generally complementary to the shape of the convex trimmer blades.

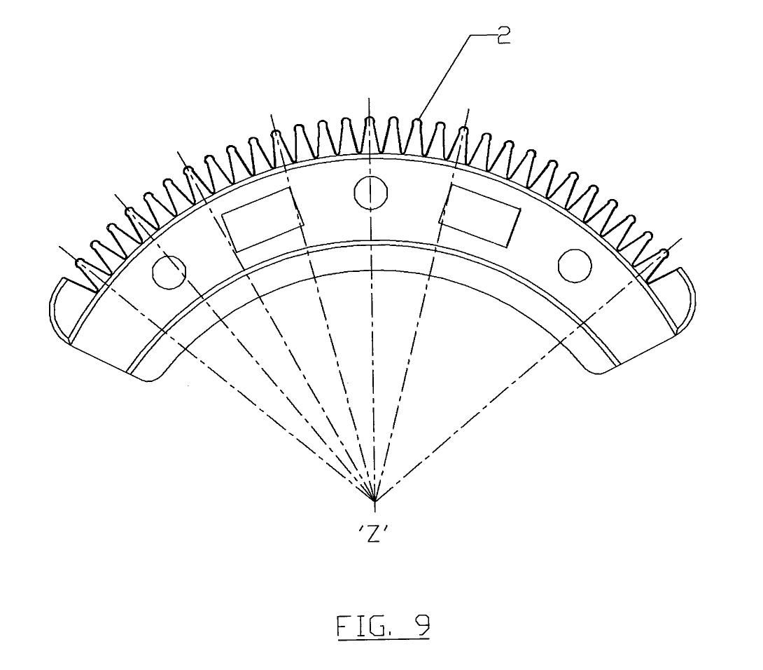

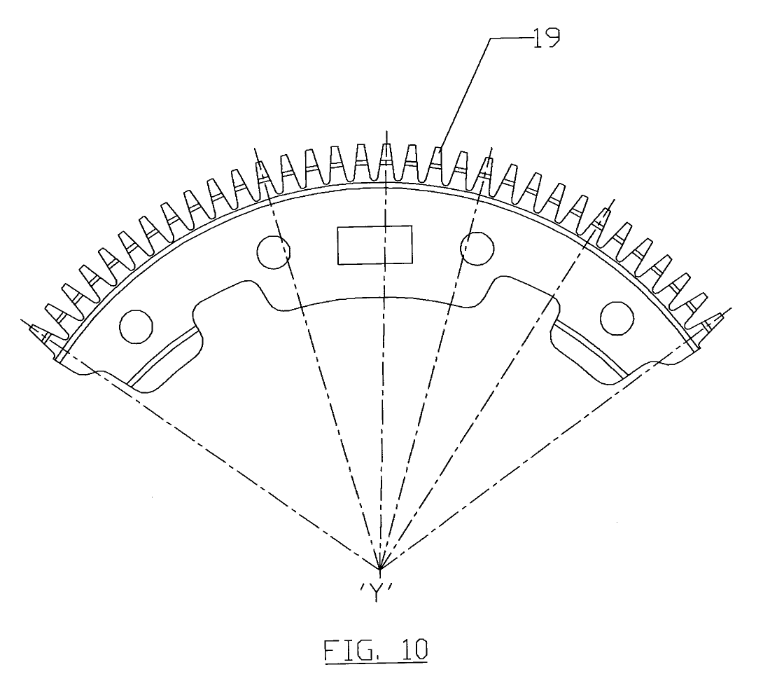

Referring now to FIG. 9 and FIG. 10, FIG. 9 is a front view of a convex stationary blade used in the convex trimmer, and FIG. 10 is a front view of a convex movable blade used in the convex trimmer. The teeth are arranged radially on both the stationary blade 2 and the movable blade 19. Therefore, the teeth are oriented radially, such that the center lines of the teeth are each pointing generally to the same center point, point Z in FIG. 9 and point Y in FIG. 10. The lines extending from point Z and point Y illustrate the radial orientation of the teeth of the stationary blade 2 and the moveable blade 19. Other orientations for the teeth may also be used.

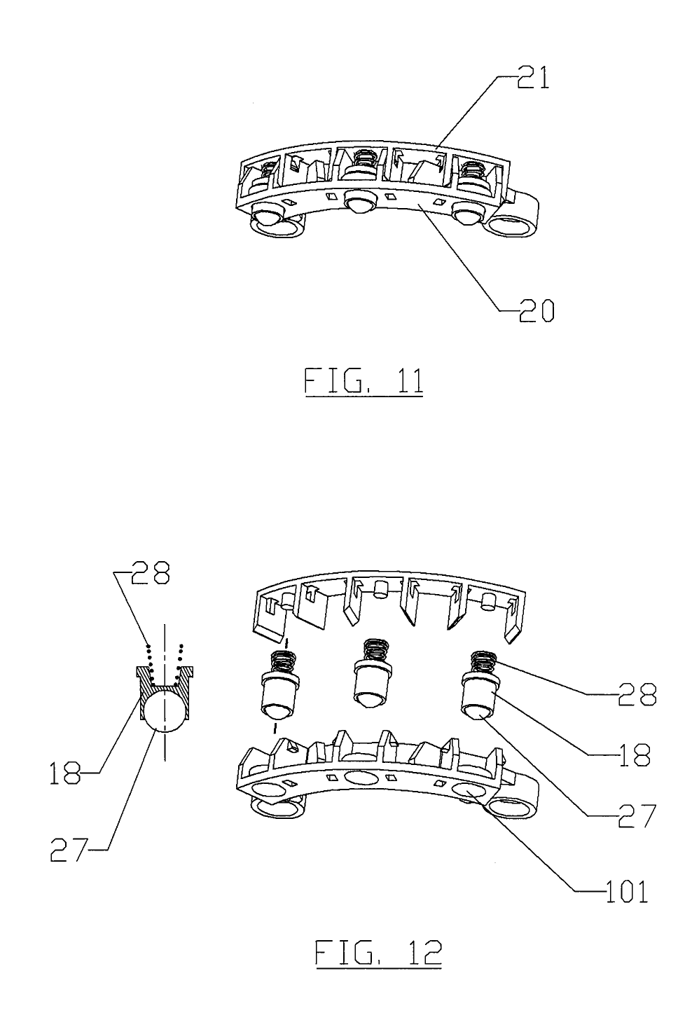

Referring now to FIG. 11 and FIG. 12, a detailed view of the clamp system is shown. FIG. 11 is a perspective view of a clamping system of the convex movable blade used in the convex trimmer. FIG. 12 is an exploded view of the clamping system shown in FIG. 11. The illustrated clamping system of the convex trimming blade includes three spherical balls 27 and a spring 28 at the back of each of the spherical balls 27. The spherical ball may be made from stainless steel, such as stainless steel ball bearings. Each spherical ball 27 is positioned on a holder 18, each holder at least partially extending through a respective circular hole 101 defined in the front clamp 20. Each of the springs may be positioned on a respective pin or holder of the rear clamp 21. The clamping system assists in providing even clamping forces on the blades during the operation of the trimmer. Also the spherical balls can assist in reducing the contact area and thereby reduce the friction of the blades.

A side sectional view of one set of the holder 18, the spring 28, and the spherical ball 27 is shown on the left of FIG. 12 for clarity. In the illustrated embodiment, the spring 28 is at least partially received into a part of the holder 18, and the spherical ball 27 is at least partially received into a part of the holder.

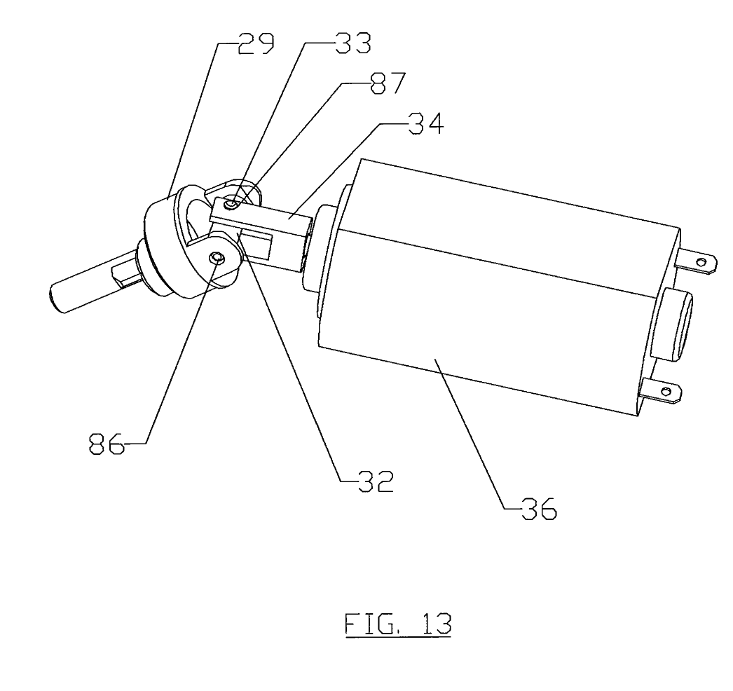

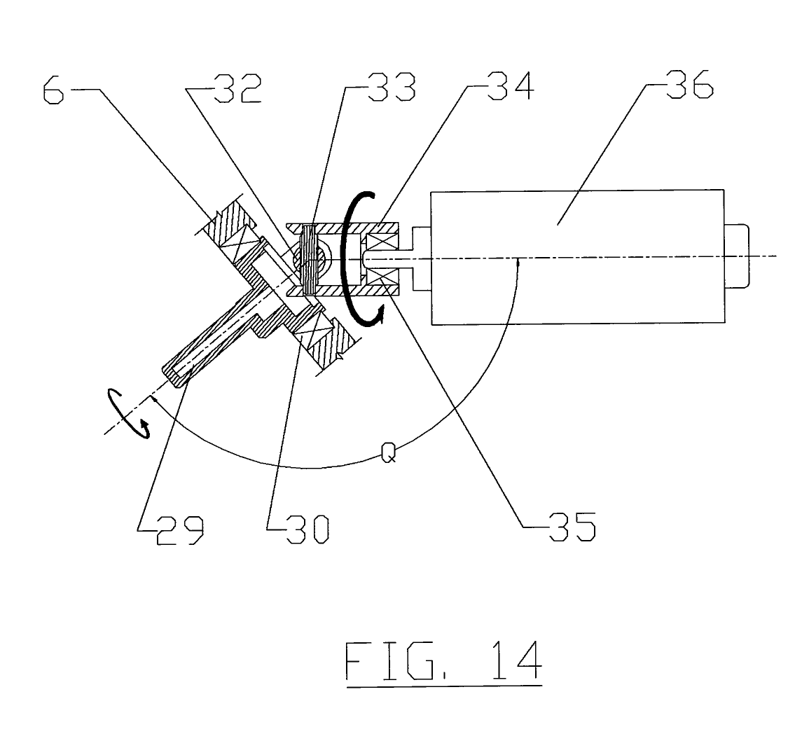

Referring now to FIGS. 13 through 16, the universal joint is described. FIG. 13 is a perspective view of a universal joint used in the shaver. FIG. 14 is a perspective sectional view of the universal joint shown in FIG. 13, showing the transmission principle of the motor driving mechanism for the shaver. The universal joint includes two portions, a motor output connector 34 and an eccentric shaft 29. The eccentric shaft 29 may be considered the driveshaft, which drives the motion and operation of the shaver and the trimmer. The motor output connector 34 may be made of plastic with a metal insert part 35 (shown in FIG. 14) tight fitted into a hole or aperture in one end of the motor output connector 34. A round hole in the center of the metal insert part 35 is tight fitted with the motor shaft of the motor 36. The connection of these two portions, motor output connector 34 and the eccentric shaft 29, is made using metal pins 32, 33. One pin 33 is inserted through a small hole in the middle part of the other pin 32. The ends of these two small pins are then fixed into respective holes 87, 86, or apertures, on the eccentric shaft 29 and the motor output connector 34, respectively. Therefore, this joint can then tolerate the angular tolerances at an angle Q. Other methods of connection may also be used.

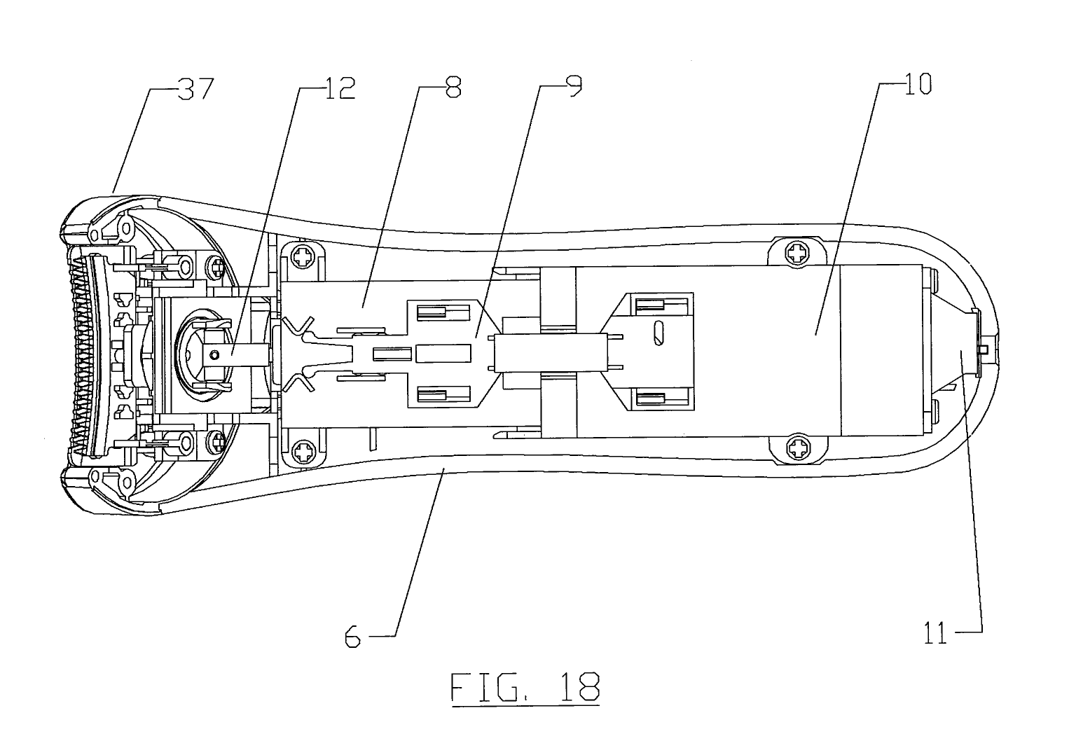

As described above, because the electric shaver head is angled at an angle E, the universal joint 12 shown in FIGS. 14 and 18 is used between the motor output shaft and the eccentric shaft, which is the driving mechanism for the attachments of the shaver 110. A universal joint can provide and maintain a smooth transmission of rotational motion even when the axis of the output shaft and the eccentric shaft 29 is inclined at, for example, angle Q.

To maintain the alignment of the output shaft and the eccentric shaft 29 and to also maintain a smooth rotation of the universal joint, a ball bearing 30 may be used to fix the eccentric shaft 29 into the lower main housing 6. The use of the ball bearing 30 may also be used to keep the desired angle, angle Q, formed between the central axis of the eccentric shaft 29 and the central axis of the motor 36.

The use of the eccentric shaft 29 can generate a linear motion of the movable blade during the used of the concave trimmer attachment, as described with reference to FIGS. 17 through 25, generally, and also generate a rotational motion for the concave movable blade during use of the concave trimmer and shaver attachment.

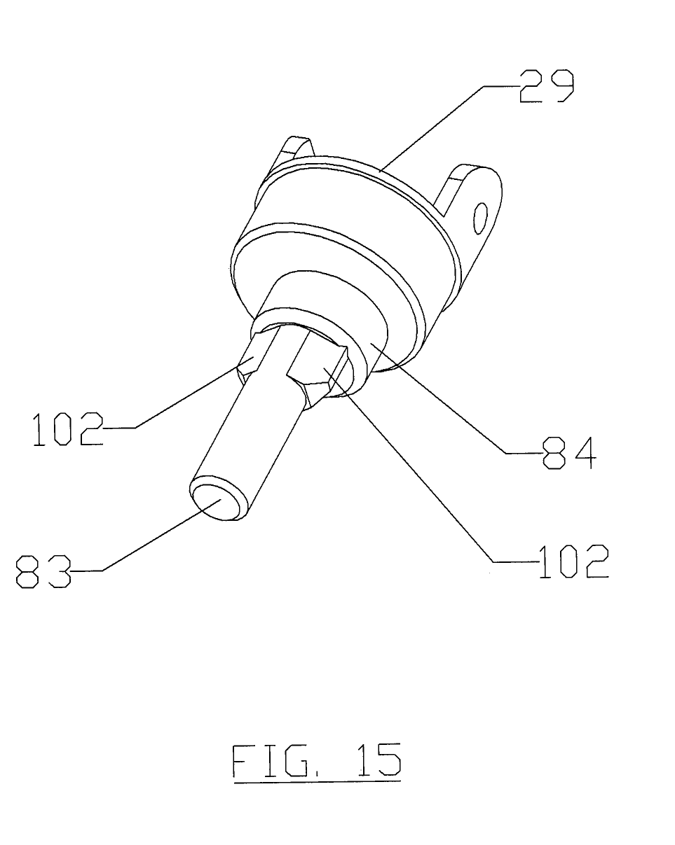

Referring now to FIG. 15, a perspective view of the eccentric shaft of the universal joint is shown. The eccentric shaft 29 is the front part of the universal joint. The central shaft 83 is used to drive the shaver and the eccentric part 84 is used to drive the convex trimmer or the concave trimmer. There are two generally triangular shaped portions 102, or wedged shape portions, on the central shaft 83 which may be used to drive the shaver cutter carrier 14 of the convex trimmer and shaver attachment.

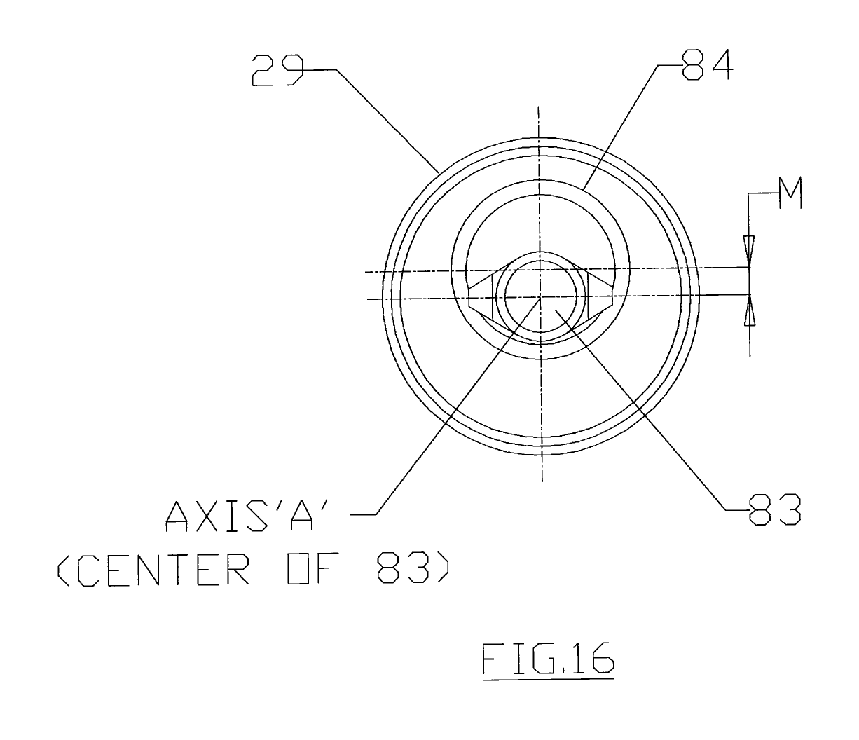

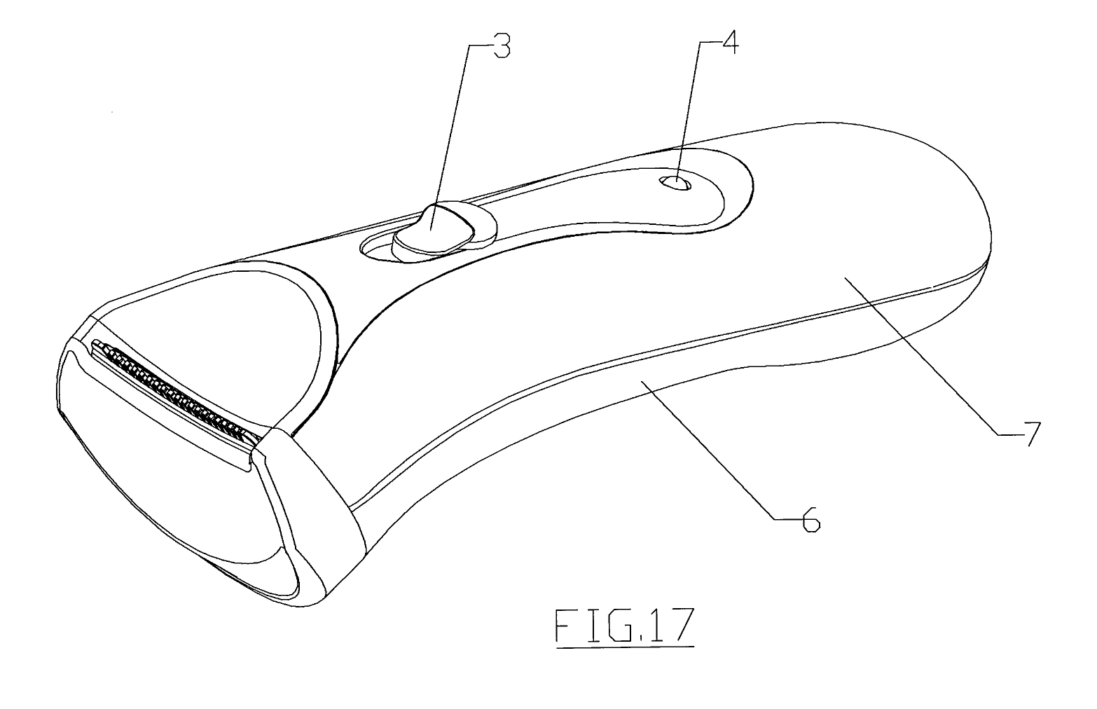

Referring to FIG. 16, an end view of the eccentric shaft shown in FIG. 15 is shown. Axis A is the center of the eccentric shaft 29 and the center of the central shaft 83 of the eccentric shaft 29. The eccentric part 84 is thereby eccentric since the center of the eccentric circular part 84 is offset from axis A by a distance of M. The central axis of the eccentric part 84 is therefore eccentric, or offset, from the center of the eccentric shaft 29, which the eccentric part 84 is coupled to, or integrally formed with.

The eccentric part 84 is received by the slotted hole 85 of the moving arm 23. Since the eccentric shaft 29 is rotating about the axis A, the rotation of this eccentric shaft 29 converts rotational motion into angular motion of the moving arm 23 about the axis C of the metal shaft 22 (see FIG. 5). This angular, left and right, motion of the moving arm then drives the convex movable blade 19, resulting in operation of the trimmer.

The eccentric part 84 is illustrated as having a generally circular shape. However, the eccentric part 84 may also have any other shape that is suitable for operation of the shaver 110. The distance M is any suitable predetermined distance to make the eccentric part 84 eccentric relative to the central axis of the eccentric shaft 29.

FIG. 17 is a perspective view of the electric shaver with a concave trimmer attachment. In the illustration, the concave trimmer is shown attached to the shaver body. The body of the electric shaver includes a power switch 3, an LED indicator 4, a lower housing 6, and an upper main housing 7.

FIG. 18 is a top sectional view of the electric shaver with the concave trimmer attachment 37, with the upper housing removed, showing the internal parts of the shaver. The components shown and described with reference to FIG. 2 are also similarly shown in FIG. 18.

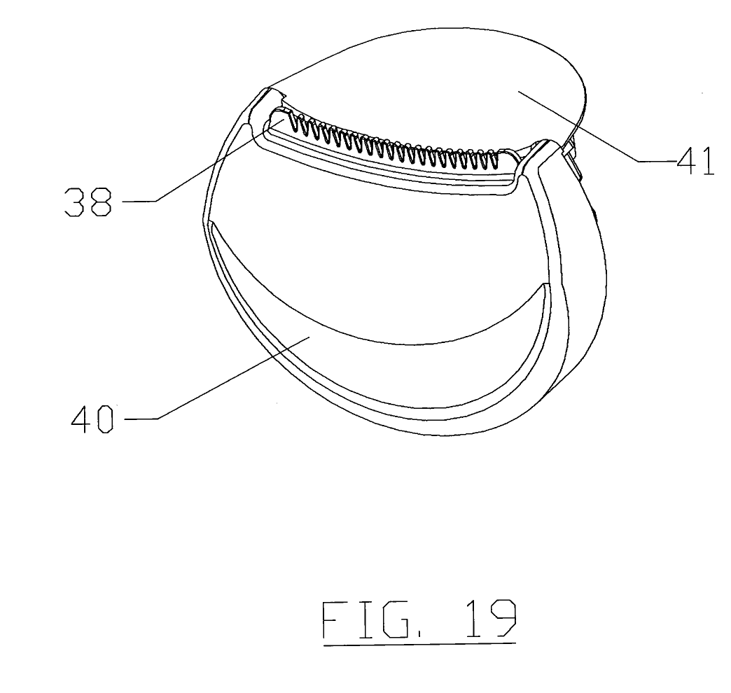

FIG. 19 is a perspective front view of the concave trimmer attachment. The concave trimmer attachment includes a concave fixed blade 38, a concave attachment front cover 40, and a rear cover 41.

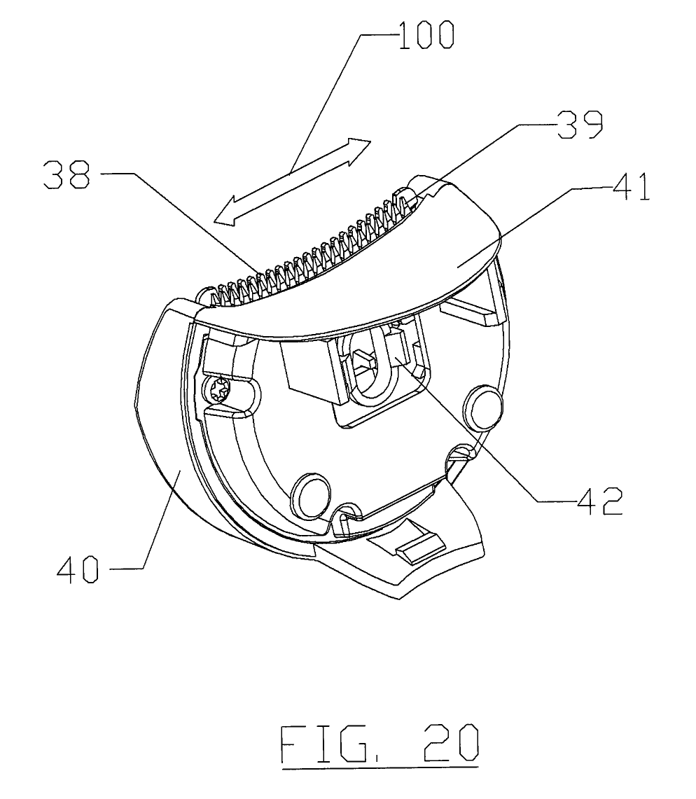

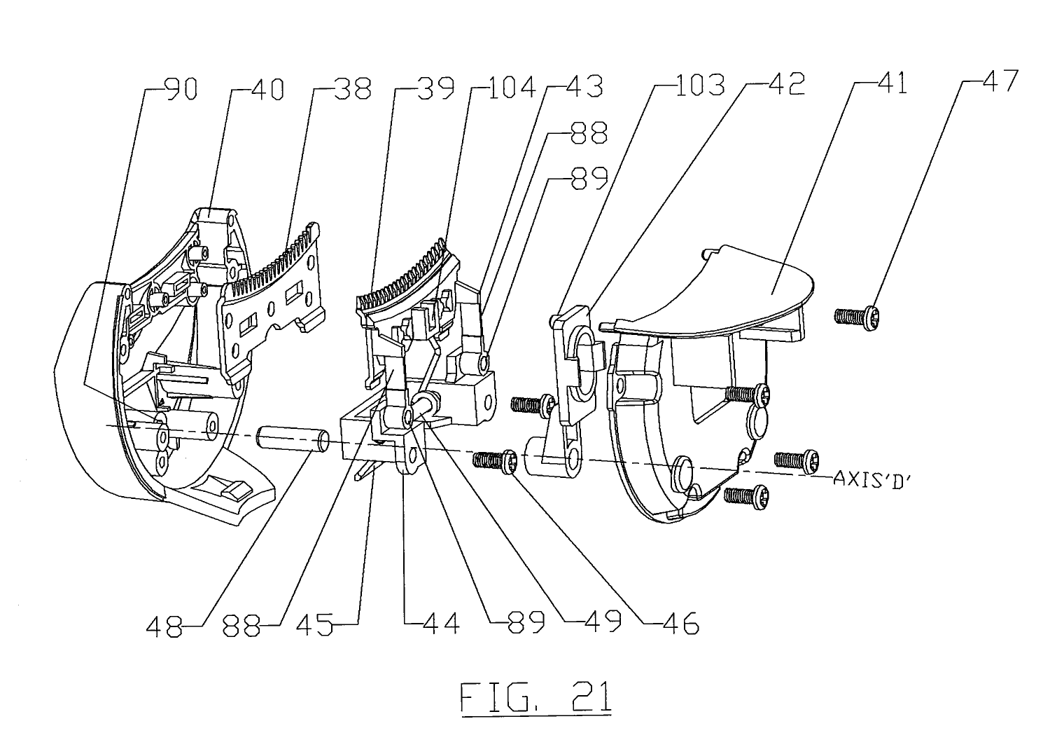

FIG. 20 is a perspective rear view of the concave trimmer attachment. The concave fixed blade 38, the concave movable blade 39, the concave attachment front cover 40, and the rear cover 41 are shown. The throw, or stroke, of the concave movable blade 39 is generally linearly from left to right, and then from right to left, repeated in quick succession during operation, in the direction as indicated by the arrow 100.

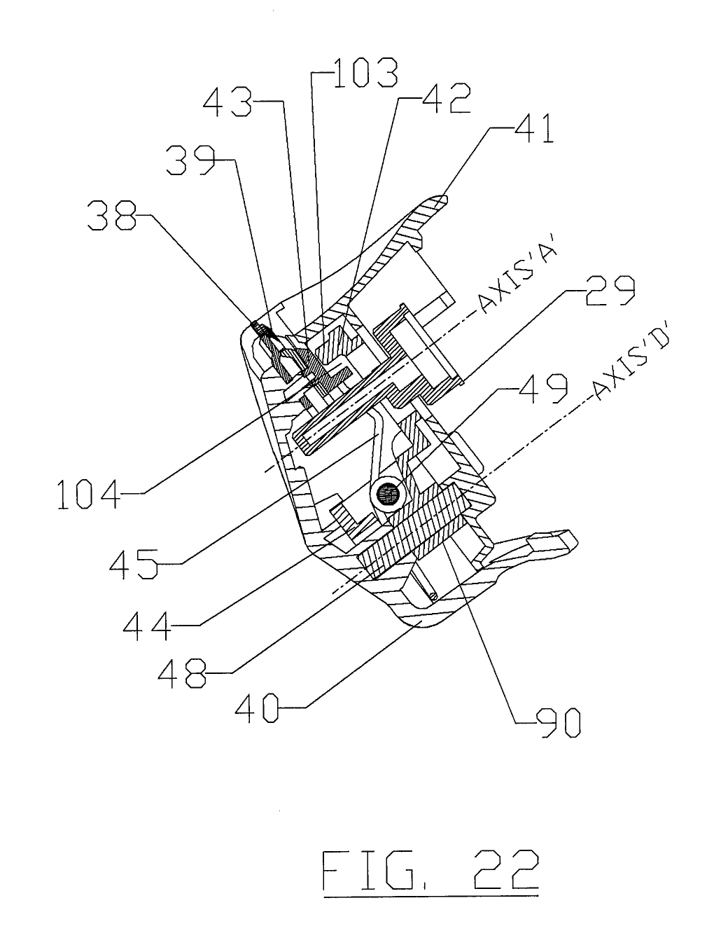

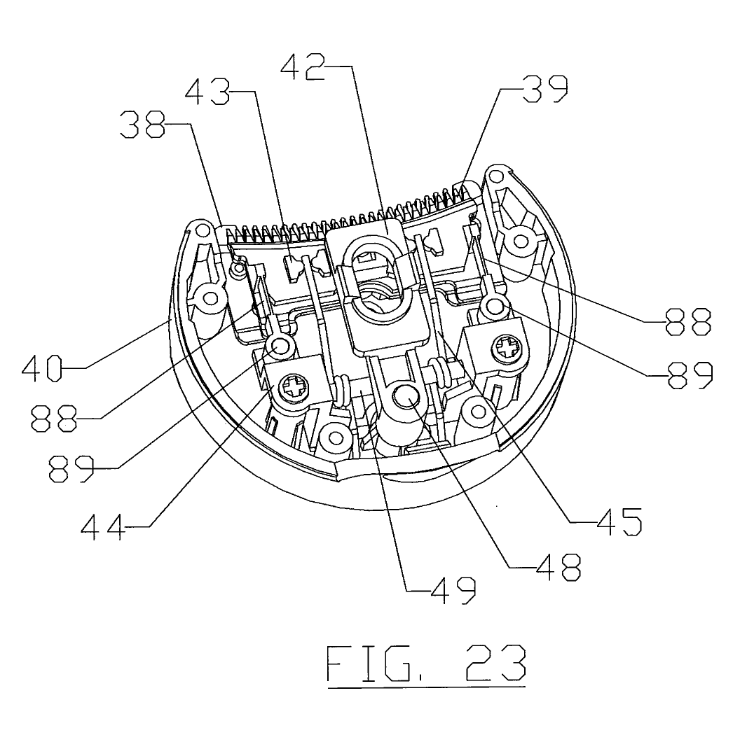

Referring now to FIGS. 21 through 23, internal workings of the concave trimmer attachment are described. FIG. 21 is an exploded view of the concave trimmer attachment showing the internal parts, FIG. 22 is a side sectional view of the concave trimmer attachment, and FIG. 23 is a perspective rear view of the concave trimmer attachment with the cover removed.

The concave movable blade 39 is mounted into the blade holder 43. To effect linear movement of the movable blade 39, two plastic supports 88, which may be integrally molded at the sides of the blade holder 43. The blade holder 43 is coupled to the spring-shaft holder 44 by pins at locations identified by reference numbers 89. Each of the two plastic supports 88 pivots about the pins identified at reference numbers 89. A spring 45 is used to hold the movable blade 39 and control the pressure between the concave fixed blade 38 and concave movable blade 39. The spring 45 is held in position by a horizontal metal shaft 49 (see FIG. 23).

During operation, the concave movable blade 39 moves in a reciprocating linear direction, the concave movable blade being driven by a moving arm 42. The moving arm 42 is pivoted about the center of the metal shaft 48, located in a shaft hole 90 of the concave front cover 40. The moving arm 42 is moved radially about axis D when driven by the eccentric shaft 29. The driving means is similar to the driving means as described with reference to the convex trimmer and shaver attachment, described above. A pin 103, which may be integrally molded on the moving arm 42, is inserted into a U-shape slot 104, which may be integrally molded on the blade holder 43. Movement of the moving arm 42 therefore drives the movement of the blade holder 43, and thereby moves the concave movable blade 39.

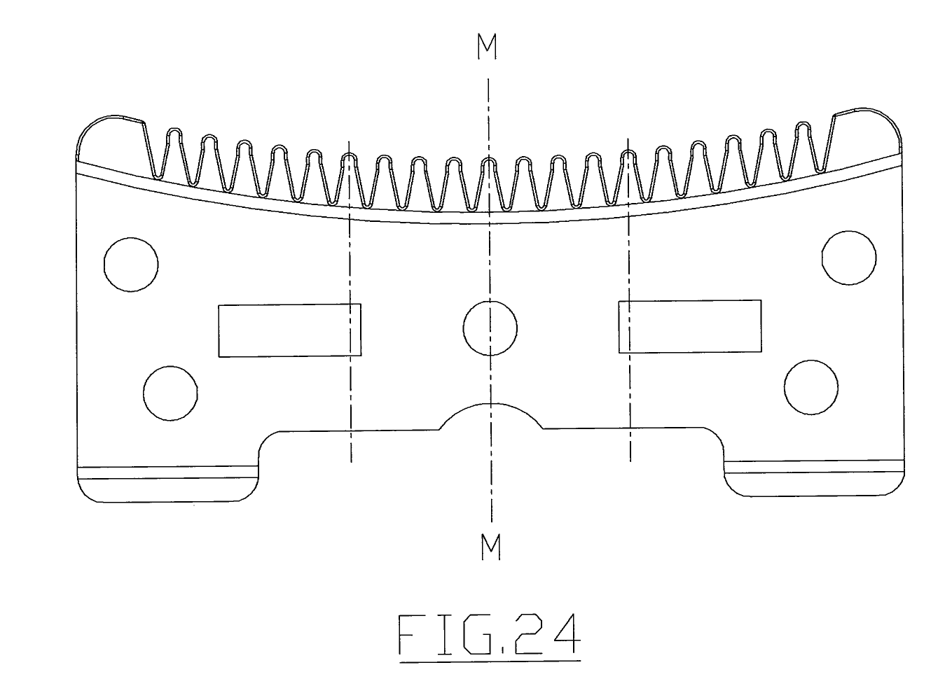

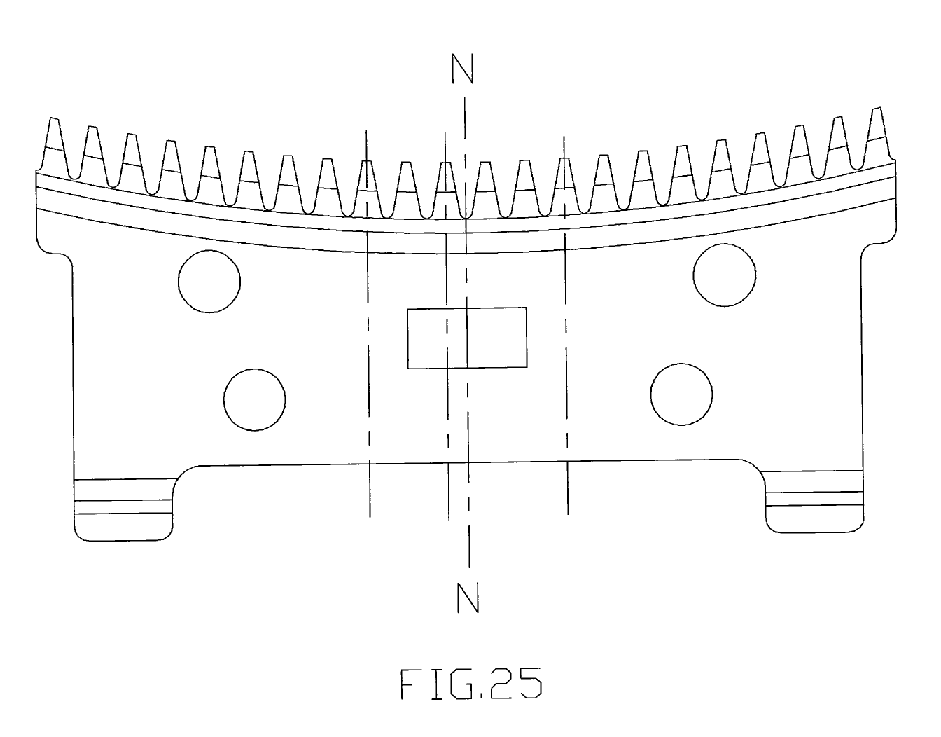

Referring now to FIGS. 24 and 25, FIG. 24 is a top view of a concave stationary blade used in the concave trimmer attachment, and FIG. 25 is a top view of a concave movable blade used in the concave trimmer attachment. The blades of the concave trimmer attachment have a concave side profile shape, arranged generally in the shape of the outer side of the sphere, as shown in FIGS. 24 and 25. The cutting teeth are not arranged radially, as are the teeth of the convex blades of the convex trimmer and shaver attachment. The teeth of the concave trimmer attachment are positioned generally parallel to each other, which may additionally simplify the manufacture and operation of the trimmer. The center line of each of the teeth will is generally parallel to the central axes, M-M and N-N, as shown in FIGS. 24 and 25, respectively. However, other orientations for the teeth may also be used.

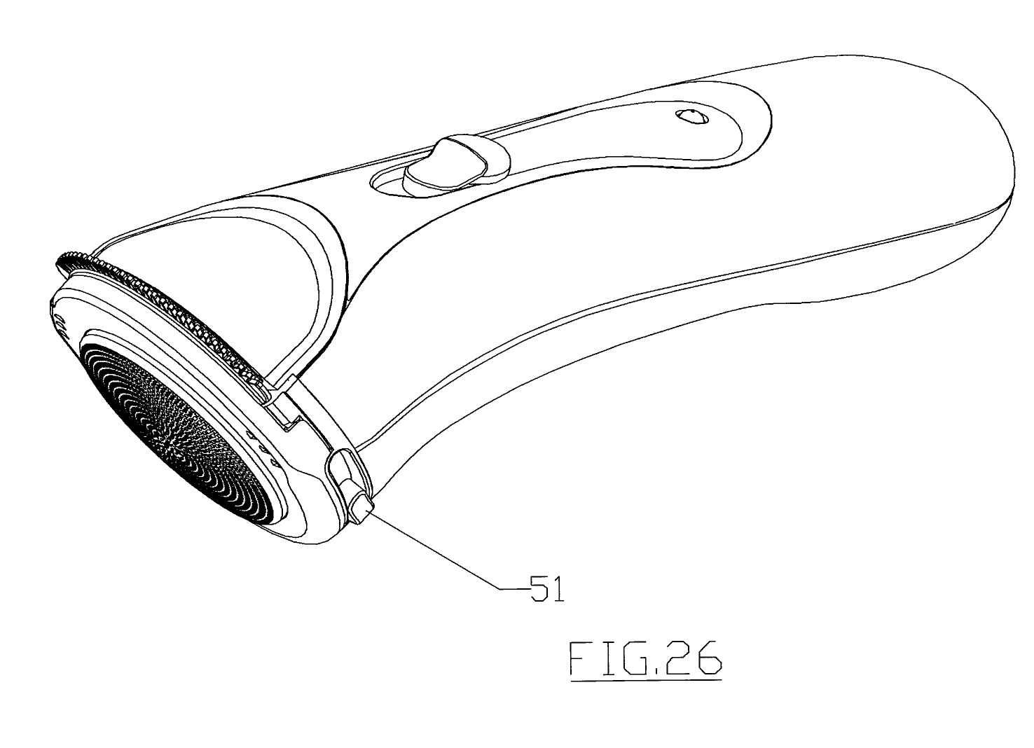

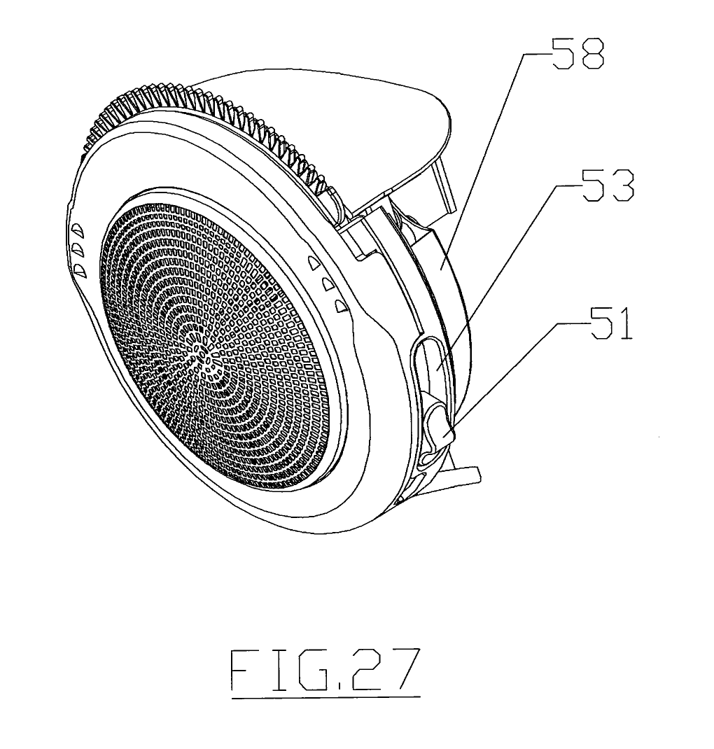

FIG. 26 is a perspective view of the electric shaver with a convex trimmer and shaver attachment with selector. The embodiment shown in FIG. 26 is similar to that shown in FIG. 1, except that the convex trimmer and shaver attachment includes a selector 51. Using the selector 51, the user can select either operation of only the shaver or operation of only the trimmer by actuating, or rotating, the selector, which is located on a side of the attachment.

FIG. 27 is a perspective front view of the convex trimmer and shaver attachment with selector. In the illustrated attachment with selector, the selector 51, a selector slot 53 in the front cover, and a rear cover 58 are shown.

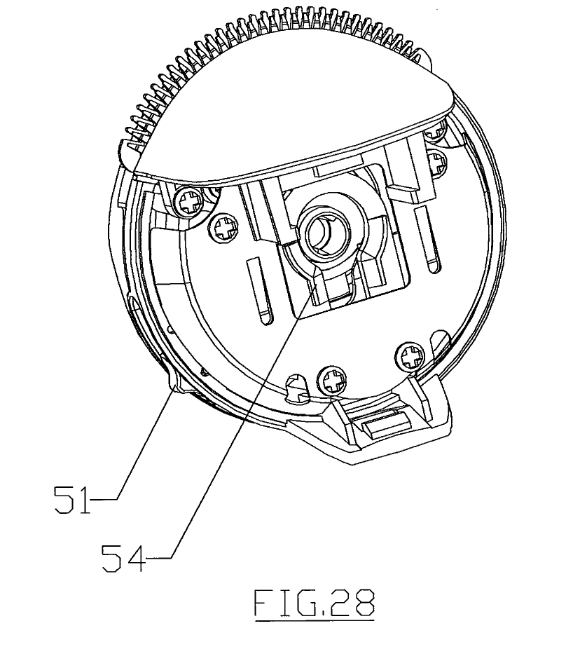

FIG. 28 is a perspective rear view of the convex trimmer and shaver attachment with selector. Shown in the perspective rear view is the selector moving arm 54, which has a different configuration from the moving arm using in the embodiment of the attachment without the selector 51 present, described with reference to FIGS. 1 through 16. It is to be understood that the embodiment of the electric shaver with the selector operates similar to the other embodiments of the electric shaver described herein, except for features expressly indicated as being different with reference to FIGS. 26 through 37. Those components identified by like reference number are to be considered similarly as described with reference to other figures and in other parts of the description.

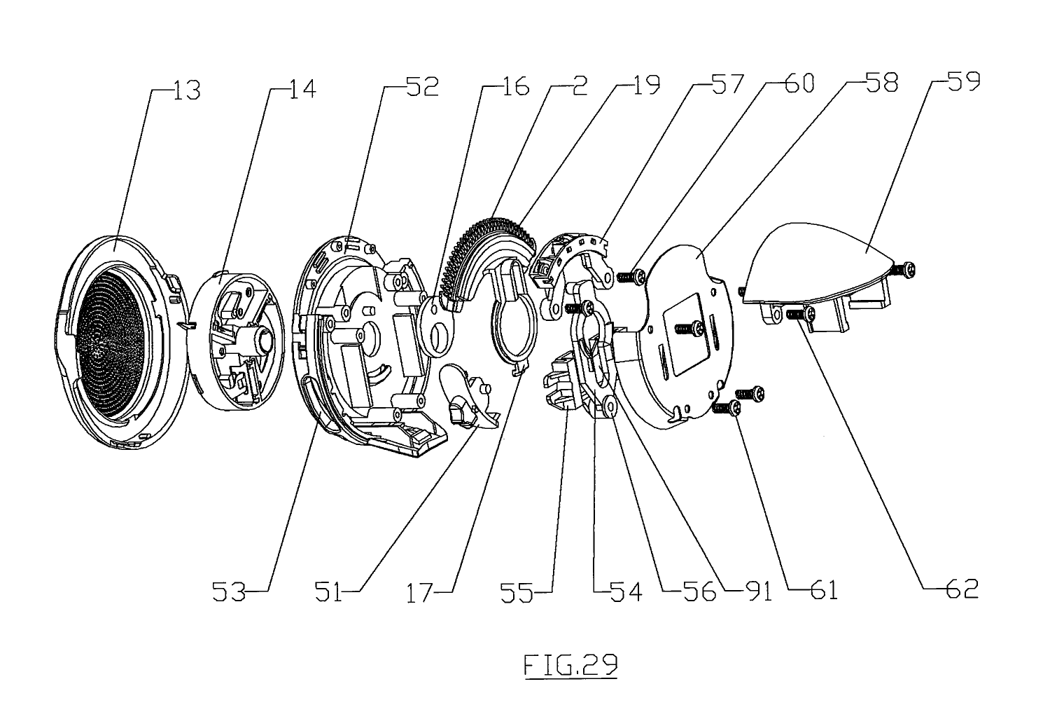

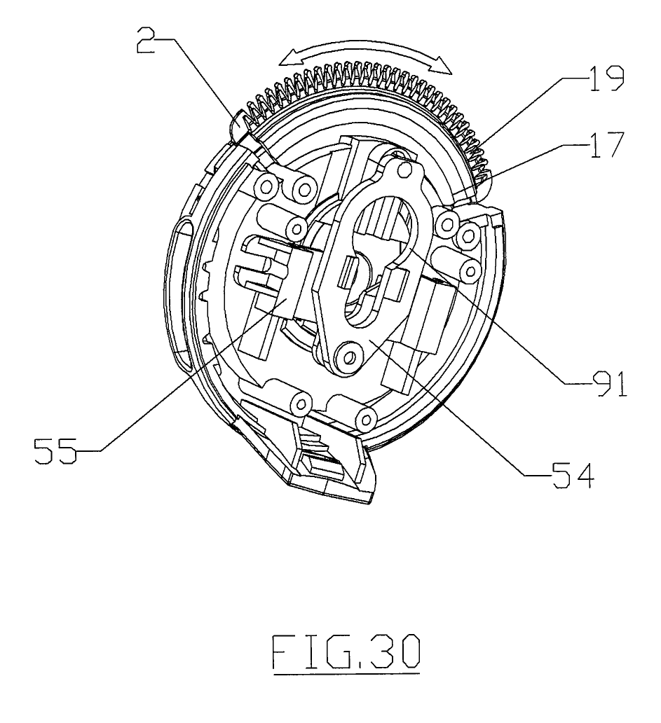

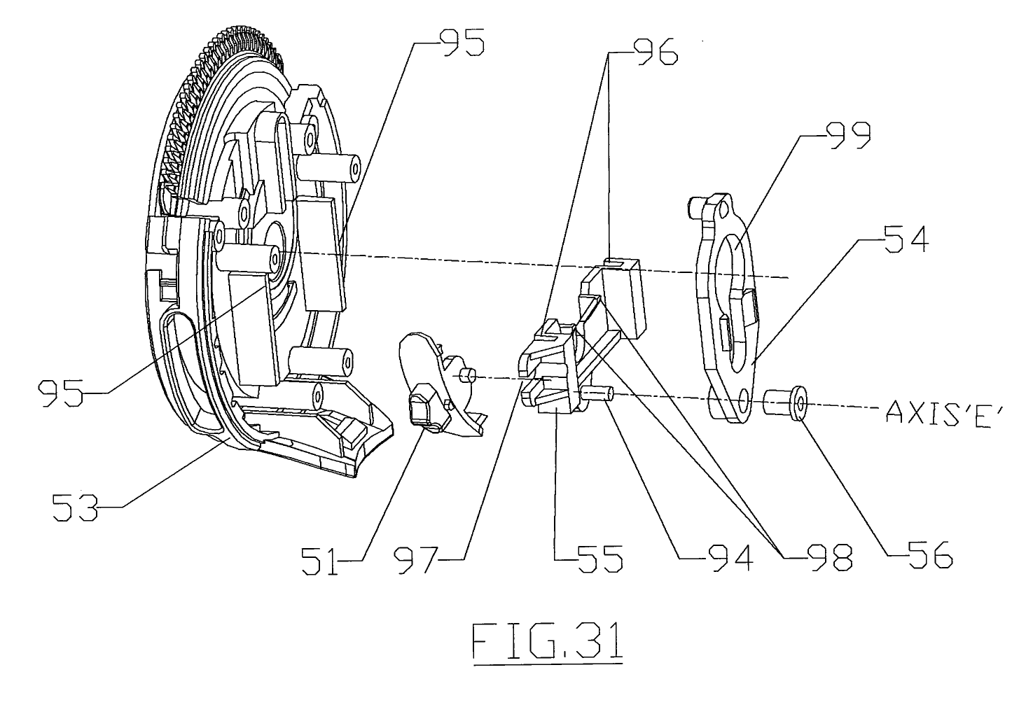

Referring generally to FIGS. 29 through 31, FIG. 29 is an exploded view of the convex trimmer and shaver attachment with selector, showing the internal parts, FIG. 30 is a perspective rear view of the convex trimmer and shaver attachment with selector, and FIG. 31 is a detailed exploded view of a part of the convex trimmer and shaver attachment with selector.

The operation of either the shaver only or the convex trimmer only, as performed using the selector, is achieved by using alternate positions of the selector moving arm 54. The convex trimmer and shaver attachment with selector, therefore, includes the addition of the selector knob 51, the selector moving arm 54, a selector control plate 55 and a selector front cover 52, including the selector slot 53 for accessing and actuating the selector 51.

The selector moving arm 54 is carried by, or in engagement with, the selector control plate 55. The selector moving arm 54 is coupled to the selector control plate 55 by a pin 94 and a metal bushing 56. The selector moving arm 54 can be moved radially about the pin 94 about axis E.

The upwards and downwards movement of the selector control plate 55 is guided by two vertical ribs 95, which are illustrated as narrow vertical ridges, on the front cover 52. Two U-shaped grooves 96 on the selector control plate 55 receive and engage with the two vertical ribs 95 and provide a control path for the vertical movement of the selector control plate 55 and the selector moving arm 54. The selector 51 may be actuated by the user to adjust the position of the selector control plate 55. A pin or protrusion on the selector 51 engages a slot 97 of the selector control plate 55, such that movement of the selector 51 causes generally vertical movement of the selector control plate 55, and thereby moves the selector moving arm 54.

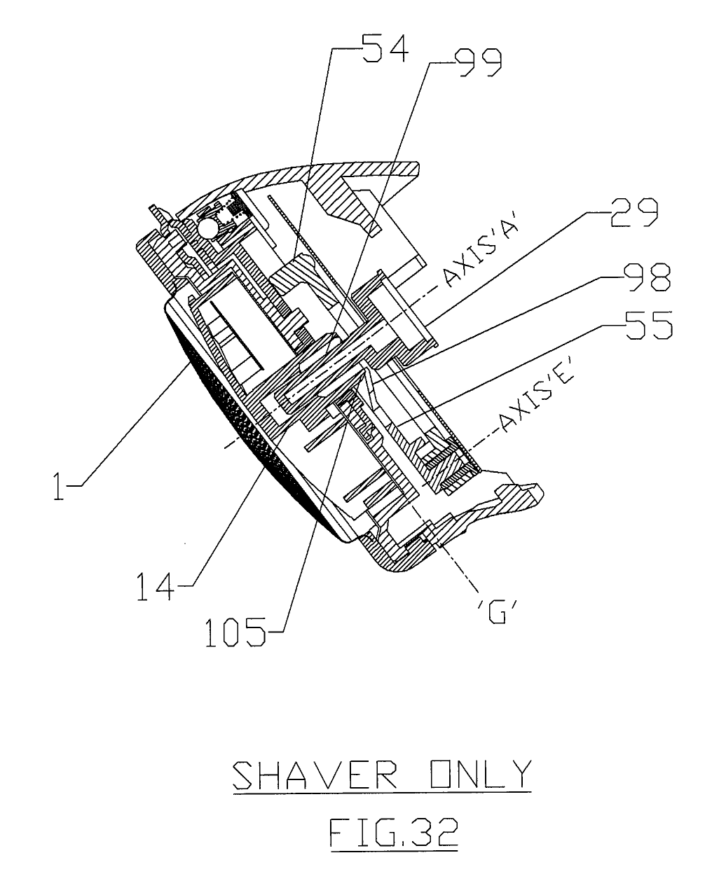

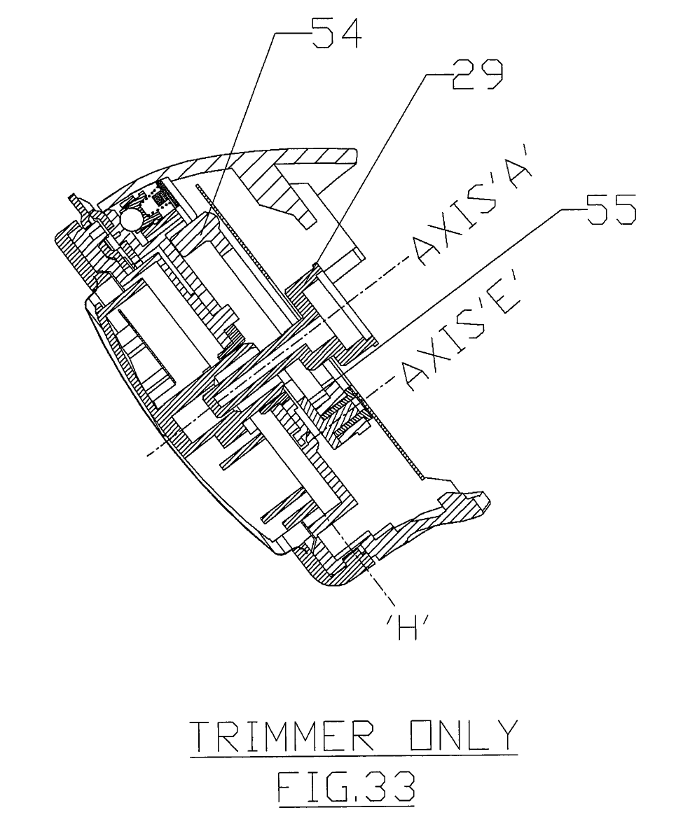

Referring specifically to FIGS. 32 and 33, FIG. 32 is a sectional view of the convex trimmer and shaver attachment with selector, with the selector in a shaver only position, and FIG. 33 is a sectional view of the convex trimmer and shaver attachment with selector, with the selector in a trimmer only position. Two wedge shape areas 98 on the selector control plate 55 are used to push the shaver cutter 14, at the location indicated by reference number 105, towards the shaver foil 1 in a direction generally along the axis A. When the selector control plate 55 is pushed in an upward direction, the two wedge shape areas 98 push the shaver cutter 14 toward the shaver foil 1, thereby releasing the shaver cutter 14 from engagement with the eccentric shaft 29. In this position of the selector control plate 55, the shaver portion of the electric shaver 110 will not operate, and only the convex trimmer will be activated during operation of the electric shaver. As shown in FIGS. 32 and 33, the shaver cutter 14 can be seen to have moved from position G. in FIG. 32, to position H, in FIG. 33, after upward movement or actuation of the selector control plate 55.

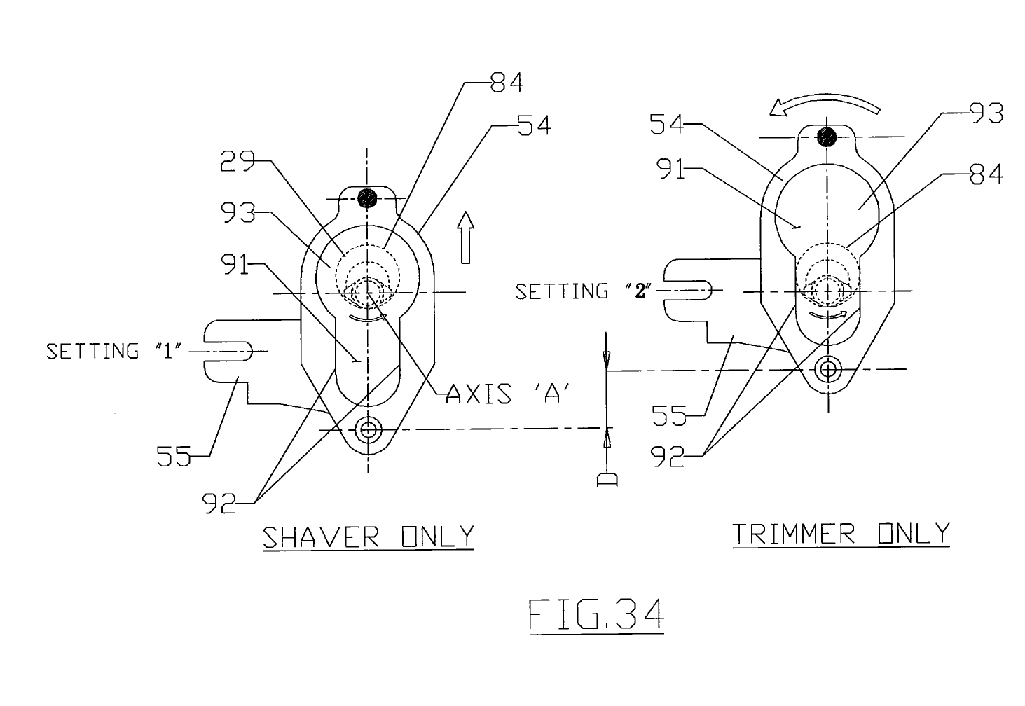

FIG. 34 is a schematic diagram showing the working principle of the selector in the convex trimmer and shaver attachment with selector. From this partial, end view schematic diagram, the movement of the selector moving arm 54 about the eccentric shaft 29 can be seen. The selector moving arm 54 defines a keyhole 91, which is a keyhole shaped opening of the selector moving arm 54. The keyhole 91 has parallel edges 92 on the lower portion of the keyhole 91 and a larger circular area 93 on the upper portion of the keyhole 91. In a first position of the selector moving arm 54, illustrated as “setting 1” in FIG. 34, during operation, the eccentric shaft 29 rotates about axis A. In the first position, the eccentric shaft 29 is located in the larger circular area 93 of the keyhole 91. In the first position, the eccentric part 84 of the eccentric shaft 29, which is illustrated by the dashed circular lines, does not contact the large hole 93 or other parts of the selector moving arm 54. Therefore, in the first position, the eccentric part 84 does not generate lateral, side to side motion in the selector moving arm 54. In another embodiment, the eccentric part 84 may make some contact with the selector moving arm 54 during operation, but such contact may be small and insufficient to drive the selector moving arm 54 in a lateral direction and thereby drive the trimmer. Accordingly, in the first position, operation of the shaver occurs while operation of the trimmer does not occur.

In a second position of the selector moving arm 54, illustrated as “setting 2” in FIG. 34, the selector moving arm 54 is moved upwards a distance D. In the second position, the eccentric shaft 29 is located generally between and proximate to the parallel edges 92 of the keyhole 91. In the second position, the eccentric part 84 of the eccentric shaft 29 will contact the selector moving arm 54 during rotation of the eccentric shaft 29, thereby generating lateral motion of the selector moving arm 54, and thereby driving the movable trimmer blade. Accordingly, in the second position, operation of the trimmer occurs.

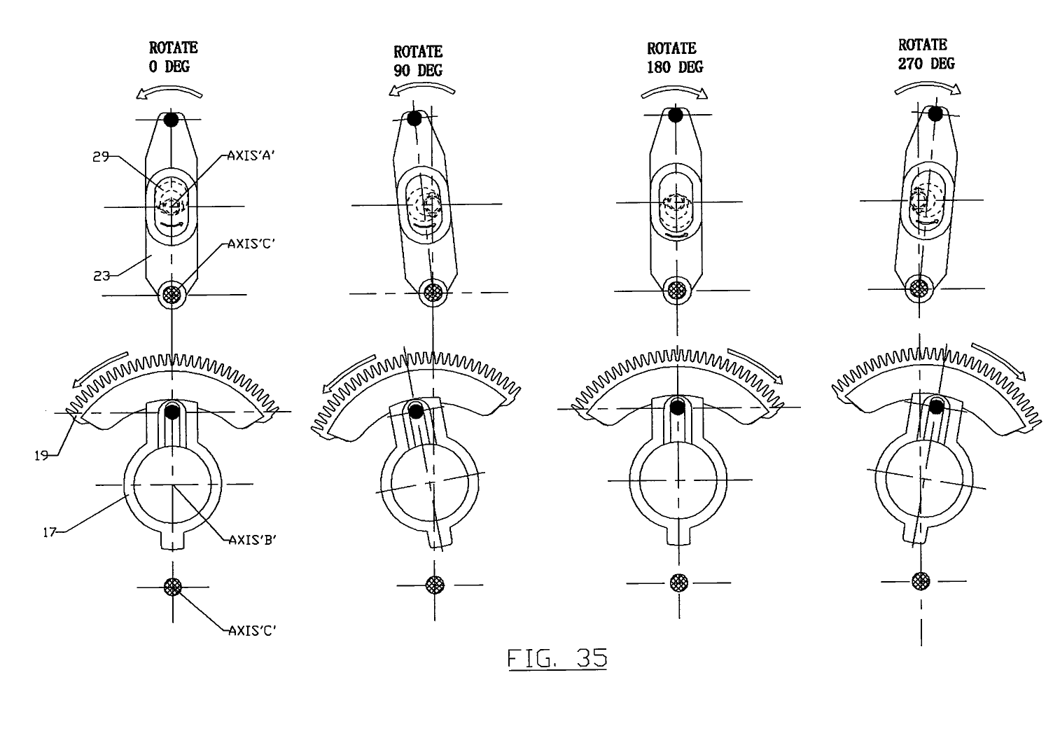

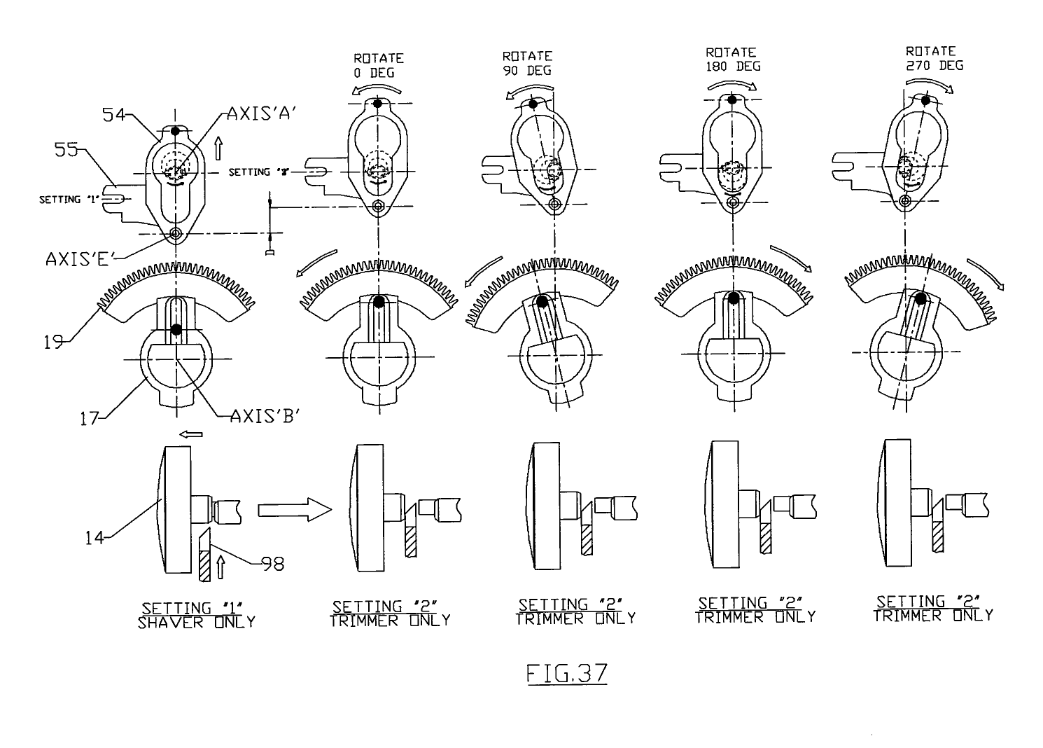

Referring now to FIGS. 35 through 37, schematic diagrams, showing to cooperation of multiple components over time, are provided. Each of diagrams illustrates the relative motion of two or more components over time. Components that are vertically aligned are to be considered as belonging to the same period of time. From left to right, the vertical groups of components progress over time through one revolution of the motor shaft, and therefore, one revolution of the eccentric shaft 29, which is operably coupled to the motor and motor shaft. Each figure shows four vertical groups, each occurring after 90 degrees of rotation of the eccentric shaft 29, the first vertical group is designated as zero degrees, the second vertical group shown at 90 degrees, the third vertical group shown at 180 degrees, and the fourth vertical group shown at 270 degrees of rotation (the four rightmost vertical groups in FIG. 37). During operation of the electric shaver, rotation of the eccentric shaft occurs at relatively high speeds, thereby repeating the illustrated processes successively.

Referring to FIG. 35, a schematic diagram showing the driving principle of the blades of the convex trimmer and shaver attachment is shown. In the upper row of the figure, the motion of the moving arm 23 is shown during one revolution of the driveshaft. In the lower row of the figure, the motion of the moving blade holder 17 and the convex movable blade 19, relative to the moving arm 23, is shown during one revolution of the driveshaft. In the upper row, the dashed circular lines identify the eccentric part of the driveshaft. At zero degrees of the revolution, the eccentric part is located in the upper portion of the slotted hole 85 and the moving arm 23 is generally vertical, and the convex movable blade 19 is in a generally vertical position. At 90 degrees of the revolution, the eccentric part rotates counterclockwise to a position that pivots the moving arm 23 to the left. Similarly, since the moving blade holder 17 is coupled to the moving arm 23, the moving blade holder and the convex movable blade 19 also pivots to the left about axis C, creating rotational or pivoting motion of the movable blade 19. At 180 degrees of the revolution, the eccentric part is located in the lower portion of the slotted hole 85, and the moving arm 23 returns to a generally vertical position. The moving blade holder and the convex movable blade 19 also pivot back toward the generally vertical position. At 270 degrees of the revolution, the eccentric part rotates to a position that pivots the moving arm 23 to the right, and also pivots the moving blade holder and the convex movable blade 19 to the right. After another 90 degree rotation, the driveshaft returns to the zero degree position. Because the eccentric part fits horizontally closely within the slotted hole, rotation of the eccentric part generates lateral movement of the moving arm 23 to the left and to the right. Because the slot is vertically elongated, however, the rotation of the eccentric part does not necessarily generate vertical motion in the moving arm.

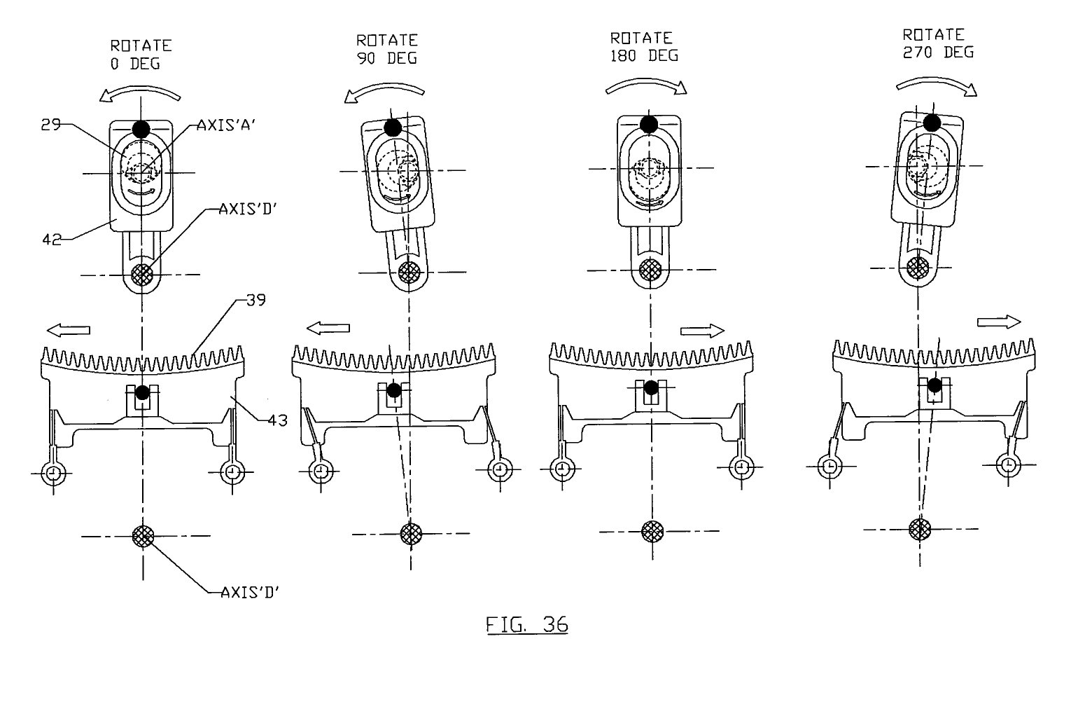

Referring to FIG. 36, a schematic diagram showing the driving principle of the blades of the concave trimmer attachment is shown. In the diagram of FIG. 36, the motion of the moving arm 42 operation similarly to the motion of the moving arm 23 in FIG. 35. The motion of the concave movable blade 39 is also similar to the motion of the movable convex blade of FIG. 35. However, because the blade holder 43 pivots on the two plastic supports 88 about pivot points located closer to the blade holder 43, the motion of the blade holder 43, and therefore the motion of the concave movable blade 39, is substantially lateral, from left to right.

Referring to FIG. 37, a schematic diagram showing the driving principle of the trimmer blades and shaver blades of the convex trimmer and shaver attachment with selector is shown. In the upper row of the figure, the motion of the selector moving arm is shown, in the middle row, the motion of the moving blade holder and the convex movable blade, relative to the selector moving arm, is shown during one revolution of the driveshaft, and in the lower row, the connection of the driveshaft to the shaver cutter 14, relative to the position of the selector moving arm, is shown. The left most vertical group of components in FIG. 37 shows the selector moving arm 54 and the selector control plate 55 in the first position, and in the first position, the eccentric shaft is located at the larger circular area of the selector moving arm 54, and therefore little or no motion of the selector moving arm 54 or convex movable blade occurs. When the selector moving arm 54 and the selector control plate 55 are in the second position, as illustrated in the four rightmost vertical groups, the selector moving arm and the moving blade holder operate similar to that described with reference to FIG. 35, because the eccentric shaft is located between the narrower portion of the keyhole 91. However, with reference to the lower row, it can be seen that, when the selector control plate 55 is in the first position, the driveshaft, or eccentric shaft 29, engages the shaver cutter 14, and when the selector control plate 55 is in the second position, the wedge shaped area separates the shaver cutter 14 from the driveshaft and the shaver cutter 14 will not be driven by the driveshaft during operation of the electric shaver.

The electric shaver 110 may be provided with one attachment or with a combination of one or more attachments. In one embodiment, using the convex trimmer and shaver attachment, the trimmer and the shaver cutter operate at the same time when the power is switched on. The trimmer may be used first, by holding the shaver at an angle so that the shaver foil is not against the skin surface, to trim the hairs to a desired minimum length. Then, the shaver foil may be placed against the skin surface to shave the remaining hairs to a shorter length, as can be performed with the shaver portion of the electric shaver. Also, the trimmer and shaver may used simultaneously such that hairs are trimmed by the trimmer and then shaved, in a contiguous motion. Also, while the above attachments are described as being “attachments,” therefore being removable and attachable to the electric shaver 110 body, embodiment of the electric shaver may also include any suitable combinations of the shaver and the trimmer non-removably coupled to the electric shaver body. For example, instead of being attachments, each of the herein described attachments may be integrally formed with the electric shaver body.

The concave trimmer attachment operates in a generally linear motion and may be applied to the underarm areas, or other areas of the body, where the shape of the body is generally convex, like the outer side of a sphere. After trimming using the concave trimmer attachment, if desired, the user can then change to use the shaver attachment. In another embodiment, the user may use the convex trimmer and shaver attachment with the selector 51 and select the desired operation of the electric shaver 110.

While the convex trimmer and shaver attachment with selector was described above with a shaver only operation and a trimmer only operation, other combinations may be provided in an attachment. For example, with a modification of the wedge shaped areas 98, the attachment may provide for selection between a shaver only operation and a shaver and trimmer together operation. In another embodiment, for example, the attachment may include more than two selector positions, the user able to select among operating the trimmer only, the shaver only, or the trimmer and shaver simultaneously. One advantage of the selector is the ability to operate either the trimmer or shaver alone, thereby reducing the required energy output, and as an energy saving feature, prolonging the use of the battery or reducing the amount of electricity used.

Also, while the convex trimmer and shaver attachment combined the shaver operation with the convex trimmer, the attachment may also include a combination of a concave trimmer with the shaver operation. And while the trimmer blades were illustrated as having a particular shape and configuration, other shapes and configurations may be used without departing from the scope of the present invention.

Those skilled in the art will appreciate that the above-described system may be implemented in a variety of configurations. For example, while certain components were described has having certain shapes and configurations, other shapes and configurations may be used without departing from the scope of the present invention. Also, while the various above-described components have been described as having certain criteria, such as material and whether a part is integrally formed with other parts, other components and variations in the shape and integration of the parts may also be made without departing from the scope of the present invention.

The previous description of the exemplary embodiments is provided to enable any person skilled in the art to make and/or use the present invention. While the invention has been described with respect to particular illustrated embodiments, various modifications to these embodiments will readily be apparent to those skilled in the art, and the generic principles defined herein may be applied to other embodiments without departing from the spirit or scope of the invention. It is therefore desired that the present embodiments be considered in all respects as illustrative and not restrictive. Accordingly, the present invention is not intended to be limited to the embodiments described above but is to be accorded the widest scope consistent with the principles and novel features disclosed herein.

What is claimed is:

1. An electric shaver comprising:
a body having a head end and a motor contained within the body, the motor having a motor shaft coupled to a driveshaft, the body further having a power source for operating the motor, and a switch for engaging the motor;
an attachment removably attached to the head end of the body, the attachment operably coupled to the driveshaft, the attachment including a shaver and a trimmer, the trimmer including a convex stationary blade connected to the attachment and a convex cutting blade at least partially within the attachment movable against the convex stationary blade; and
wherein during rotation of the driveshaft, the driveshaft drives operation of the shaver and the trimmer.

2. The electric shaver of claim 1, further comprising a second attachment configured for removable coupling to the head end of the body, the second attachment having a concave trimmer, the concave trimmer including a concave stationary blade connected to the second attachment and a concave cutting blade contained at least partially within the second attachment, the concave cutting blade movable against the concave stationary blade.

3. The electric shaver of claim 2, wherein the second attachment, when coupled to the body, is configured for operable coupling to the driveshaft, wherein the driveshaft drives operation of the concave trimmer.

4. The electric shaver of claim 3, wherein the attachment and the second attachment are configured for alternate coupling to the body of the electric shaver.

5. The electric shaver of claim 1, wherein the body further includes a handle, wherein the head end forms a first predetermined angle with the handle.

6. The electric shaver of claim 5, wherein the first predetermined angle is between approximately 180 degrees and approximately 90 degrees.

7. The electric shaver of claim 5, further comprising a universal joint within the body, the motor shaft coupled to the driveshaft by the universal joint.

8. The electric shaver of claim 7, wherein during engagement of the motor, the motor shaft rotates about a first axis and the driveshaft rotates about a second axis, wherein the universal joint transfers the rotation of the motor shaft about the first axis into rotation of the driveshaft about the second axis, and wherein the first axis and the second axis form a second predetermined angle, wherein the first predetermined angle is approximately equal to the second predetermined angle.

9. The electric shaver of claim 1, wherein the attachment further includes a selector movable between a first position and a second position, wherein when the selector is located in the first position the shaver operates individually, and when the selector is located in the second position the trimmer operates individually.

10. The electric shaver of claim 9, wherein the attachment further includes a selector control plate and a moving arm movable by the selector control plate, wherein the moving arm drives the convex cutting blade, and wherein in the first position, the driveshaft engages the shaver individually, and wherein in the second position, the driveshaft engages the moving arm individually.

11. An electric shaver comprising:
a body having a head end and a motor contained within the body, the motor having a motor shaft coupled to a driveshaft, the body further having a power source for operating the motor, and a switch for engaging the motor;
a first attachment configured for removable attachment to the head end of the body, the first attachment including a shaver and a convex trimmer, wherein upon attachment to the body, the first attachment is operably coupled to the driveshaft, wherein the first attachment includes a convex stationary blade connected to the attachment and a convex cutting blade at least partially within the attachment movable against the convex stationary blade, and wherein the driveshaft drives operation of the shaver and convex trimmer; and
a second attachment configured for removable attachment to the head end of body, the second attachment including a concave trimmer, wherein upon attachment to the body, the second attachment is operably coupled to the driveshaft, wherein the second attachment includes a concave stationary blade connected to the attachment and a concave cutting blade at least partially within the attachment movable against the convex stationary blade, and wherein the driveshaft drives operation of the concave trimmer.

12. The electric shaver of claim 11, wherein the body further includes a handle, wherein the head end forms a first predetermined angle with the handle.

13. The electric shaver of claim 11, further comprising a universal joint within the body, the motor shaft coupled to the driveshaft by the universal joint, wherein during engagement of the motor, the motor shaft rotates about a first axis and the driveshaft rotates about a second axis, wherein the universal joint transfers the rotation of the motor shaft about the first axis into rotation of the driveshaft about the second axis.

14. The electric shaver of claim 11, wherein the first attachment further includes a selector movable between a first position and a second position, and when the selector is in the first position, the shaver operates individually, and when location of the selector in the second position the trimmer operates individually.

15. The electric shaver of claim 4, wherein the first attachment further includes a selector control plate and a moving arm movable by the selector control plate, wherein the moving arm drives the convex cutting blade, and wherein in the first position, the driveshaft engages the shaver individually, and wherein in the second position, the driveshaft engages the moving arm individually.

16. An electric shaver comprising:
a body having a head end, a handle, and a motor, a driveshaft, and a universal joint contained within the body, the motor having a motor shaft, wherein the motor shaft is coupled to the driveshaft by the universal joint, the body further having a power source for operating the motor, and a switch for engaging the motor, wherein the head end forms a predetermined angle with the handle;
an attachment removably attached to the head end of the body, the attachment operably coupled to the driveshaft, the attachment including a shaver and a trimmer, the trimmer including a convex stationary blade connected to the attachment and a convex cutting blade at least partially within the attachment movable against the convex stationary blade, and wherein during rotation of the driveshaft, the driveshaft drives operation of the shaver and the trimmer, the attachment further including a selector movable between a first position and a second position, a selector control plate, and a moving arm movable by the selector control plate, wherein the moving arm drives the convex cutting blade, and when the selector is located in the first position, the driveshaft engages the shaver individually, and when the selector is located in the second position, the driveshaft engages the moving arm individually.
